(19) United States
(12) Patent Application Publication
(10) Pub. No.: US 2020/0000051 A1
(43) Pub. Date: Jan. 2, 2020

(54) MODULAR TANK SYSTEM

(71) Applicant: Regis Vincent, Chonburi (TH)

(72) Inventors: Regis Vincent, Chonburi (TH); Neil Hay, Chonburi (TH)

(73) Assignee: Regis Vincent, Chonburi (TH)

(21) Appl. No.: 16/482,561

(22) PCT Filed: Jun. 29, 2017
(86) PCT No.: PCT/TH2017/000051

§ 371 Date: Jul. 31, 2019

(51) Int. Cl. A01G 31/02; A01G 27/00; A01K 61/10; A01K 63/04

(52) U.S. Cl. CPC A01G 31/02; A01G 27/003; A01K 63/047; A01K 63/045; A01K 61/10

(57) ABSTRACT

The present invention relates to an integral component based modular tank system comprising multiple H-supports configured for connecting two end-caps, multiple lateral bars, liners and specifically designed linear seal for forming a modular tank of a desired length, with no limitation of length. The system is configured to connect consecutive single modular tanks to two end-caps configured to terminate the modular tank system at respective ends; multiple lateral bars configured to transmit horizontal mechanical force between the two end-caps through the H-supports, multiple liners configured to hold the intended content of the tank; and multiple linear seals consisting of an outer seal and an inner seal configured to hydraulically seal the liners and the end-caps to each other. The modular tank system further comprising optional provision of installing a 3-part interlocking bar system, horizontal supporting bars and sprinkler system for utilizing the tank as integrated green house system. The modular tank system is also utilized as aquaponics system by further incorporating floating or non-floating trays, piping assembly, pump and specifically designed reliable automatic siphon. Thermal insulation panels may also be fitted between the lateral bars of the modular tank system for minimizing heat exchange between the content of the modular tank system and the outside environment.

### BACKGROUND

### Field

Embodiments of the present invention generally relates to the field of agronomy, aquaculture and more particularly the present invention relates to a modular tank system which can be easily assembled and disassembled as per requirements and area of applications. The present invention also relates to a method of assembling the modular tank system with very minimum human effort and expertise.

### Description of Related Art

In the twenty-first century, the world faces an environmental crisis related to food and water scarcity. Large-scale industrial farming is one of the most environmentally damaging practices on the planet. The world's population is estimated to reach 10 billion people in next 40 years, which means that humans will have to expand agricultural production of arable land to approximately 2.5 billion acres, in order to grow enough food to feed the rising population. Eighty percent of the land is suitable for farming is already in use and around 15 percent of this land has been degraded to a non-arable state due to mismanagement by using large amounts of pesticides and artificial fertilizers to grow grains, fruits, and vegetable. The World Health Organization estimates that 70 percent of the world population will live in urban areas by 2050. Unfortunately, arable land required does not exist and also there is lack of sustainable organic system to produce fresh vegetables, crops, fruits etc. in limited space.

Many countries lacks large arable land and water, needed to sustain growing human populations. They also often lack financial resources and technology for production of sufficient food, and in particular enough protein to maintain the health of human population. There are also health concerns raised by humans consuming pesticide residues on fruits, vegetables and hormones in chicken, pork and beef. Pesticide and fertilizer also adversely affect birds and animals. Local waters sources such as ponds, rivers, and streams are also polluted by runoff from pesticides and fertilizers used for local growing. Therefore, there is a need to promote a natural method of farming around the world for locally grown food in any region to produce healthier food which requires less land and water, and at the same time, is environmentally friendly.

Aquaponics has been explored for several decades as a possible solution to the foregoing environmental, energy and food shortage problems. Aquaponics is an innovative agricultural method based in ecological design that integrates aquaculture with plant production. The fish in the system produce waste, which provides necessary nutrients for plant production. By using only the waste stream of fish as a nutrient source for aquaponically grown plants, both can be raised in a re-circulating system without the need for additional inputs such as fertilizers or pesticides. Such systems reduce water usage by 70-95 percent and save through re-circulating feedstock; the only water loss is due to evaporation and plants consumption while growing. Compared to soil farming they can deliver 30 percent faster time to harvest. They can be deployed anywhere with suitable light, including impermeable surfaces such as rooftops and parking lots, as well on non-arable land and indoor. Today, commercial aquaponics production exists primarily in controlled environments, such as greenhouses or outdoor locations with favorable climates, using methods and equipment that draw from both the hydroponics and aquaculture industries. Conventional aquaponics systems are not climate controlled and are not designed to be plug-and-play or to be modular enough to be easily moved to different locations.

Aquaponics tanks are used as an integral part of aquaponics systems. The aquaponics tanks developed heretofore are designed for caste-in-situ construction. Existing aquaponics tanks currently used are built with either wood, concrete, steel covered with pond liners, or in heavy fiberglass bolted together on the floor. The aquaponics tanks used heretofore are not modular or customizable and requires special tools and special skills for assembling such as steel welding, concrete construction, and mechanical handwork.

The aquaponics tanks encountered therefore are of large size and are difficult to transport from one place to another. A mechanical supporting frame is used to hold the aquaponics tank at a place. The usual practice involves building a mechanical supporting frame made up of wood, concrete, or steel and need special skills and tools for assembling.

Currently, the hydraulic sealing in the aquaponics tanks is done by using soft liner or paint, making the aquaponics tanks vulnerable for leakage of water and prone to catastrophic system failures such as death of aquatic animals and plants due to design flaws.

Although there are some portable aquaponics tanks available in the prior art. Generally, the portable aquaponics tanks are formed, by cutting small cylindrical tanks along with their central axis to provide half cylinder or barrel tanks of fixed short length. But the half barrel tanks formed are not providing a continuous tank for vegetable rafts to float all the way and also prone to leakage of water. Although there are some modular tanks available made of fiberglass, these tanks are heavy, costly, complex to install, difficult to transport, and also lack rigidity. The installation of fiberglass tanks requires tools for assemble, and specialist technician to guaranty the sealing between the tanks. The fiberglass tanks are also installed on the floor and therefore do not provide safe healthy working height environment or framing, useful for an integrated greenhouse structure.

Growing crops and plants using Deep Water Culture (DWC) aquaponics technique, also called raft aquaponics or floating bed systems, is currently enjoying extensive attention. In DWC aquaponics technique, the plants are grown on floating rafts or floating trays that floats on top of water supporting the plants. However, some detrimental details prevent this growing method from really breaking through. Growing crops on top of floating trays has several major disadvantages as germs can develop over the floating trays and disinfection of floating trays is not really possible. Moreover, the floating trays are not stable. Also, the growing plant such as lettuce or endives in floating trays opens the door for Microdochium panattonianum, a fungal plant pathogen, which seriously affects the plant.

One of the most popular aquaponics techniques used is the Flood and Drain Aquaponics. In flood and drain aquaponics, fish effluent water is pumped through a solid support medium e.g., gravel, expanded clay balls, or cinder rock. This nutrient-rich water is cycled through the system, when medium is completely flooded, then drained at short intervals. The solid support medium serves dual purpose of providing structure for plant roots to grow and surface area allowing proliferation of aerobic nitrifying bacteria, which is essential for converting nitrogen in effluent suitable for the plants' nutrient uptake. Flood-and-drain cycling in aquaponics systems can be controlled by electronic timers, which regulates activity of water pumps or by non-mechanical devices called Bell Siphons. Bell Siphons are flow rate dependant devices and needs pressure to build up on top of the cap to push air for draining water from the valve. If inlet flow rate of water is higher than required, the tank remains full and kills plants by soaking them in the water. If the inlet flow rate of water is low, the bell siphon is not able to suck-in the air to stop draining of water and the tank will remain empty and plants are killed due to water deficiency. Due to frequent problems such as clogging, the pump flow rate changes and come out of the fine window in which the bell siphon works. The bell siphon then either fails to trigger the drainage or keeps draining continuously at low level, leaving the tank either full or empty all the time. If the flow rate changes for any reason in the bell siphon, it will ultimately lead to death of plants.

The aquaponics tanks encountered heretofore have been complex and labor intensive to operate, difficult to construct because there has been no standard design that has proven to be easy to operate. The tanks are often poorly constructed with inferior materials requiring constant attention to leaks, challenges for disposal of fish waste, careful maintenance of pH levels, micronutrient depletion and water temperature. Therefore existing aquaponics tanks used are not modular, customizable and easy to transport. In addition, prior aquaponics tanks have been difficult to maintain and are prone to catastrophic system failures such as death of fishes and plants due to design flaws in actual aquaponics system. Also the bell siphon used in aquaponics system is unreliable due to narrow operating window with respect to flow rate and needs to be constantly monitored.

In order to ameliorate above discussed disadvantages of currently used aquaponics tanks system, it is desirable to develop a standardized component based modular tank system which can be customized based on client needs, and shipped anywhere in the world for assembly and operation by semi-skilled labor. There is also requirement to develop an innovative non-floating trays ensuring plant protection from germs and pathogens. Also there is a need to develop an innovative purposely designed reliable automatic siphon or flood and drain siphon ensuring reliable flooding and draining of water from the modular tank system.

It is therefore the primary objective of the invention is to provide an integrated and long continuous profile modular tank system which can be easily transported, assembled and disassembled as one wishes without any tools, with semi-skilled labor and without requiring too much human effort.

It is an object of the invention is to provide an affordable and light-weight modular tank system with endless long tank with a smooth continuous profile, which can be easily assembled and disassembled in minutes with minimal use of tools and semi-skilled labor.

It is further object of the invention is to provide a robust and easy to clean modular tank system which is elevated from the ground at an appropriate height in order to provide a safe and healthy working height environment for laborers.

It is yet further object of the invention is to provide a light-weight and transportable modular tank system, which can be vertically stacked in an area where space is limited and as per requirement.

It is still further object of the invention to provide a modular tank comprising a two-part seal ensuring linear hydraulic sealing in between different components of the modular tank preventing leakage of water from the tank.

It is further object of the invention to provide a modular tank system having a provision to install an integrated greenhouse system with vertical mechanical plant supporting system.

It is yet further object of the invention to provide a modular tank system which can be used as aquaponic deep water culture beds, aquaponics hydrotron or gravel bed systems in aquaponics industry for providing sufficient resources to the planet population for sustaining growth.

It is still further object of the invention to provide a modular tank system which can be also used as tables, feed troughs for farm animals, and any other application like for example drink troughs for Gigs and festivals.

It is further object of the invention to provide an automatic reliable siphon ensuring reliable flooding and draining process in the modular tank with very large flow rate operating window.

Other objects of the invention will be apparent from the following description

### SUMMARY

Embodiment in accordance with the present invention discloses a modular tank system is provided herein. The modular tank system comprising: one or more H-supports configured to connect one or more end-caps, one or more lateral bars, one or more liners, one or more linear seal for forming a single modular tank and further connecting the single modular tank consecutively; one or more end-caps configured to terminate the modular tank system at respective ends; one or more lateral bars configured to transmit horizontal mechanical force between the H-supports, multiple liners configured to hold intended content of the tank; and one of more linear seals consisting of an outer seal and an inner seal configured to hydraulically seal the liners and end-caps with each other.

In one embodiment in accordance with the present invention, the modular tank system comprising the H-support which is used to connect the end-caps, the lateral bars, the liner and the linear seal for forming a single modular tank and further connecting the single modular tank consecutively for forming modular tank system. The H-support also transmits weight of the modular tank system to the ground. The H-support comprises pre-fabricated grooves and surface areas for holding linear seal, lateral bars, locking bar and end-caps. The H-support also comprises holes at bottom of the H-support to bolt the modular tank system to the ground. The H-support also supports the 3-bar interlocking system while utilizing the modular tank system for supporting the growth of plants and a green house plastic film system.

In one another embodiment in accordance with the present invention, the modular tank system comprising the end-caps, which are configured to terminate the modular tank system at respective ends. The end-cap comprises pre-fabricated at least one top-end clamping connectors and locking bar, which locked inside the pre-fabricated grooves in the H-Support to transmit lateral mechanical force to the H-support.

In one embodiment in accordance with the present invention, the modular tank system comprising lateral bars which are configured to transmit horizontal mechanical force between the H-supports and mechanically support the liner and its content. The lateral bar comprises a pre-fabricated interlocking aperture, which fitted inside the pre-fabricated grooves in the H-Support and forms an interlocked structure in U-like interlocking shape.

In one embodiment in accordance with the present invention, the modular tank system comprising liner which is configured to hold the intended content of the tank which fitted inside the H-support and multiple lateral bars.

In one another embodiment in accordance with the present invention, the modular tank system comprising linear seal consisting of an outer seal and an inner seal. The outer seal and the inner seal of the linear seals are joined together for assuring the seal between two liners or between a liner and an end-cap. The H-supports assures the mechanical support of the two-part linear seal.

Embodiment in accordance with the present invention discloses a method of assembling the modular tank system is provided herein. The method includes putting an outer seal on first H-support. The outer seal is locked in place in the H-support. Further, the method includes installing a locking bar in the H-support and sliding an end-cap in the first H-support incorporating the outer seal in place. The pre-fabricated top-end clamping connectors and locks inside the pre-fabricated grooves of the H-Support transmitting lateral mechanical force to the H-support. The method further includes inserting multiple lateral bars in the first H-support incorporating the outer seal and the end-cap in place. The method further includes attaching the second H-support having the outer seal fixed in place and thus forming a supporting structure. The method further includes putting the liner in place in the supporting structure.

Embodiment in accordance with the present invention discloses a method of assembling the modular tank system having single liner. The method further includes sliding the second end-cap in the second H-support. Further, an inner seal is clipped above the outer seal and the liner by applying thumb pressure over it and thus, forming a single modular tank.

Embodiment in accordance with the present invention discloses a method of assembling the modular tank system having multiple liners. The method further includes increasing the length of the modular tank system, simply by further adding H-supports, the outer seals, the multiple lateral bars, liners and inner seals in respective positions to the single modular tank consecutively in series before and inserting the second locking bar and end-cap in the last H-support after the required length is reached. Further, the assembly process is completed, by clipping the last inner seal over the outer seal of the last H-support to form a modular tank system of required length and specifications. The modular tank system can be designed of any length as per user requirement.

Embodiment in accordance with the present invention a modular tank system is utilized as an aquaponics system is provided herein. The aquaponics system comprising the first modular tank system configured to contain support medium required for growing plants, one or more non floating trays configured for holding the growing plants, the second modular tank system configured for raising aquatic animals, a filtration system configured to clean water draining from the second modular tank system, a pump configured to pump water from the second modular tank system, and a piping assembly consisting of an outlet pipe and an inlet pipe configured for interconnecting and circulating water between the modular tanks system.

In one embodiment in accordance with the present invention, the piping assembly comprising the outlet pipe which is configured to drain out excess water from the first modular tank system for maintaining adequate water level in the first modular tank system, required for growth of the plants and the inlet pipe configured to carry filtered water to the first modular tank system configured for holding the plants for providing required nutrients for growing plants.

In one other embodiment in accordance with the present invention, the modular tank system is utilized as the aquaponics system also further comprising an optional provision for installing 3-part interlocking bar system comprising vertical, transversal and lateral supporting bars and horizontal supporting bars for providing support and strength to tall plants.

Embodiment in accordance with the present invention discloses a modular tank system utilized as the flood and drain (FD) aquaponics system is provided herein. The modular tank system used as a FD aquaponics system comprising the first modular tank system configured to contain support medium required for growing plants; the second modular tank system configured for raising aquatic animals; a pump configured to pump the water from the second modular tank system to the first modular tank system, an inlet pipe of piping assembly configured for interconnecting and circulating water between the two modular tank system; and a specifically designed reliable automatic siphon configured for regulating flow of the water in the modular tank system. The first modular tank system and the second modular tank system are vertically stacked modular tank system configured to hold the aquatic animals and the plants, the support media, the piping assembly configured to pump water, the filtration system and the pump.

In one embodiment of the present invention, the specifically designed reliable automatic siphon is disclosed for regulating flow of the water in the modular tank system is. The automatic reliable siphon comprising a floater, configured to move up and down as the water is filling up in and draining out of the modular tank system; a collector, configured to collect water flowing from the tank through the floater out of the tank system; a locking screw, configured for retaining the floater at its maximum desired height during filling of the modular tank system; a plunger, configured for controlling the closing and opening of the flow into the floater during the filling and the draining processes of the modular tank system; a sealing mechanical assembly configured for sealing and mechanically connecting the reliable automatic siphon at the bottom of the tank and guiding the floater up and down movement; a protecting sleeve configured for protecting the floater from the support medium such as but not limited to gravel, clay balls etc and allowing free movement of the floater; and the drain pipe configured for draining the water from the collector when the water level in the automatic siphon reaches to the predetermined maximum level.

These and other advantages will be apparent from the present application of the embodiments is described herein. Also, further areas of applicability of the present invention will become apparent from the detailed description provided hereinafter.

The preceding is a simplified summary to provide an understanding of some aspects of embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1 illustrates a schematic representation of side elevation view of the modular tank system comprising the H-support, the linear seal, the end-cap, the lateral bars and the liners are assembled together in a suitable manner to form the modular tank system;

FIG. 2 illustrates a schematic representation of the H-support configured to provide support to the modular tank system and enlarged view of grooves and holes present in the H-support designed for specific purposes;

FIG. 3 illustrates a schematic representation of side elevation view of the H-support with outer seal and enlarged view of the locking mechanism between the H-support and the outer seal;

FIG. 4 illustrates a schematic representation of the end-cap, configured for transmitting lateral mechanical force to the H-support and enlarged view of the top-end clamping connectors present in the end-cap and locking bar which are interlocked within the grooves of the H-support and an interlocked structure of the end-cap with the H-support;

FIG. 5 illustrates a schematic representation of side elevation view showing connection of multiple lateral bars between the H-supports. Also showing detailed view of interlocking mechanism of lateral bar 502 connected between H-supports 202 and lateral bar 502 interlocking aperture 504 present at both ends of the lateral bar 502;

FIG. 6 illustrates a schematic representation of a supporting structure formed by connecting the at least two H-supports incorporating the outer seal in place connected through the multiple lateral bars;

FIG. 7 illustrates a schematic representation of the liner, configured to hold the intended content of the modular tank system;

FIG. 8 illustrates a schematic representation of a single modular tank without the second end-cap comprising the H-support with the outer seal, the inner seal, the end-cap, the lateral bars and the liner which are further connected in series to form a long and continuous profile modular tank;

FIG. 9 illustrates a schematic representation of an enlarged view of consecutive connection between the single modular tank and interlocking mechanism between the H-support and the lateral bars and also showing the clipping mechanism between the inner seal, the outer seal, the liner and the end-cap;

FIG. 10 illustrates a schematic representation of top sectional view of the linear seal consisting the outer seal and the inner seal and interconnection between the outer seal and the inner seal of the modular tank system;

FIG. 11 illustrates a schematic representation of detailed view of the H-support with the end-cap, the inner seal, the locking bar and the outer seal integrated in place of the modular tank system;

FIG. 12 illustrates a schematic representation of top sectional view of interconnecting clipping mechanism between the outer seal and the inner seal of the modular tank system;

FIG. 13 (a) illustrates a schematic representation of fully comprehensive step-by-step details of the method of assembling the single modular tank;

FIG. 13 (b) illustrates a schematic representation of fully comprehensive step-by-step details of the method of assembling of the long profile modular tank system;

FIG. 14 illustrates a schematic representation of the modular tank system fitted with an integrated greenhouse support system comprising 3-part interlocking bars connected with vertical, transversal, lateral supporting bars for mechanical support of tall plants;

FIG. 15 illustrates a schematic representation of detailed view of the 3-part interlocking bars system comprising the vertical, the transversal, the lateral supporting bars and an enlarged view of interlocked structure formed by the vertical supporting bars, the transversal supporting bars and the lateral supporting bars of the 3-part interlocking bar system;

FIG. 16 illustrates a schematic representation of the modular tank system used as an integrated greenhouse system with sprinkler system comprising 3-part interlocking bar system, a sprinkler pipe and horizontal supporting bars connected between the holes, provided in the lateral supporting bar of the 3-part interlocking bar system;

FIG. 17 illustrates a schematic representation of the modular tank system fitted with an insolation system comprising of thermal insulation panels squeezed between the lateral bars in the modular tank system;

FIG. 18 illustrates a schematic representation of detailed view of the modular tank system fitted with thermal insulation panels to prevent heat exchange between the tank content and the atmosphere as shown in FIG. 17;

FIG. 19 illustrates a schematic representation of various options of the non-floating trays used for holding the plants in the modular tank system;

FIG. 20 illustrates a schematic representation of modular tank system with non-floating trays and an enlarged view showing placement of non-floating trays in the modular tank system;

FIG. 21 illustrates a schematic representation of the modular tank system utilized as aquaponics system comprising non floating trays, 3-part interlocking bar system, supporting bars, sprinkler pipe and a separate single modular tank fitted with a pump and piping assembly configured to interconnect both the tanks of the aquaponics system;

FIG. 22 illustrates a schematic representation of sectional and detailed view of piping assembly, comprising the outlet pipe and the inlet pipe interconnecting the modular tank system of the aquaponics system as shown in FIG. 21;

FIG. 23 illustrates a schematic representation of side elevation and inner view of the modular tank system, set up as the aquaponics system depicting connection and position of the outlet pipe of the piping assembly through the end-cap of the modular tank system, configured to hold plants of the aquaponics system as shown in FIG. 21. The outlet pipe may also be configured through the liner of the modular tank system;

FIG. 24 illustrates a schematic representation of inner sectional view of the modular tank system showing water level adjustment in the modular tank system by changing the length of straight vertical portion or stand pipe of the outlet pipe of the piping assembly as shown in FIG. 21;

FIG. 25 illustrates a schematic representation of outer and side view of the modular tank system showing inlet pipe inserted through the openings on top of the end-cap of the modular tank system as shown in FIG. 21;

FIG. 26 illustrates a schematic representation of side elevation view of the modular tank system utilized as the flood and drain (FD) aquaponics system comprising a reliable automatic siphon, a pump and the inlet pipe interconnecting the modular tank system of the FD aquaponics system; FIG. 26 (a) depicting the top view of the FD aquaponics system detailing the position of the automatic siphon; FIG. 26 (b) depicting bottom view of the FD aquaponics system detailing the automatic siphon extending between the modular tank system; and FIG. 26 (c) showing that liner of top modular tank system is modified for inserting the automatic siphon;

FIG. 27 (a) illustrates schematic representation of 3-D view of the automatic siphon detailing position of the automatic siphon and its components;

FIG. 27 (b) illustrates a schematic representation of sectional view of automatic siphon detailing the position of automatic siphon, its components and showing the functioning of the automatic siphon during filling and draining position of the first modular tank system.

The headings used herein are for organizational purposes only and are not meant to be used to limit the scope of the description or the claims. As used throughout this application, the word “may” and “can” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

As used throughout this application, the word “may” is used in a permissive sense (i.e., meaning having the potential to), rather than the mandatory sense (i.e., meaning must). Similarly, the words “include”, “including”, and “includes” mean including but not limited to.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The following description of the preferred embodiment(s) is merely exemplary in nature and is in no way intended to limit the invention, its application, or uses.

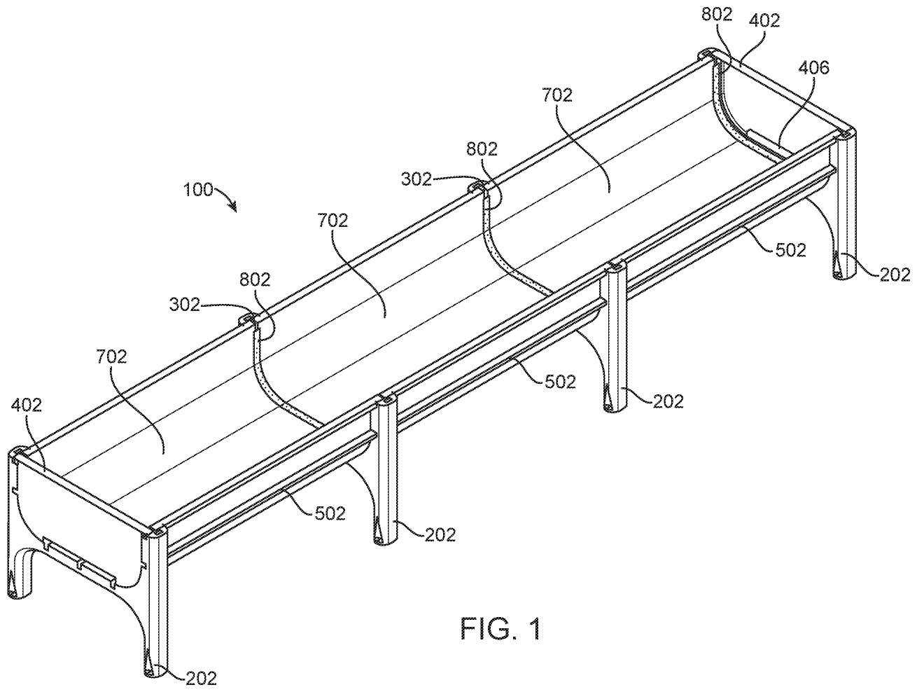

FIG. 1 illustrates a schematic representation of side elevation view of the modular tank system 100 comprising H-support, linear seal, end-cap, lateral bars and liners are assembled together in an appropriate manner to form the modular tank system 100.

An integral component based modular tank system 100 comprising multiple H-supports configured for connecting an end-cap, multiple lateral bars, a liner and a linear seal for forming a single modular tank and further connecting consecutive single modular tank; multiple end-caps configured to terminate the modular tank system 100 at respective ends; multiple lateral bars configured to transmit horizontal mechanical force between the H-supports, multiple liners configured to hold the intended content of the tank; and multiple linear seals consisting of an outer seal and an inner seal configured to seal the liners interacting with each other and with the end-caps.

The components used in the modular tank system 100 should be food grade if designed to be used in contact with food, and may include ABS plastic, polycarbonate, or other plastic or steel type materials or any combination thereof as conditions or specifications require. These components are injection molded, thermo molded, roto-molded, fabricated from stock on site or combined with other waterproof materials.

The modular tank system 100 offers a standardized complete component based system which can be custom ordered based on client needs, shipped anywhere in the world for assembly and can be assembled and disassembled by any novice person not requiring any expertise nor tools. The modular tank system 100 is an open tank system of unlimited length having mechanical and hydraulic integrity at any length.

The modular tank system 100 may also be stacked vertically on top of each other of any height thereof as conditions or specifications required, thereby forming a vertically stacked modular tank system 100 which can be used for any applications such as but not limited to container for storing water, as garden bench, an elevated Koi pond etc. and as FD aquaponics system.

The modular tank system 100 may be utilized for various functions associated with plant growth, including but not limited to aquaponics deep water culture beds, aquaponics flood and drain systems, aquaponics media (i.e. hydrotron or gravel) bed systems, grow beds for seedlings, green house garden, garden bench etc.

As the modular tank system 100 is easy to transport, assemble and disassemble, can also be used for other applications such as, feed troughs for farm animals, drink troughs for gigs and festivals, as an elevated koi pond etc. The modular tank system 100 may also be used as a table top like structure.

The modular tank system 100 allows full usage of bore cross section area of tank. The modular tank system 100 does not restrict the flow of water in the long and continuous profile tank as opposite to the other tanks used.

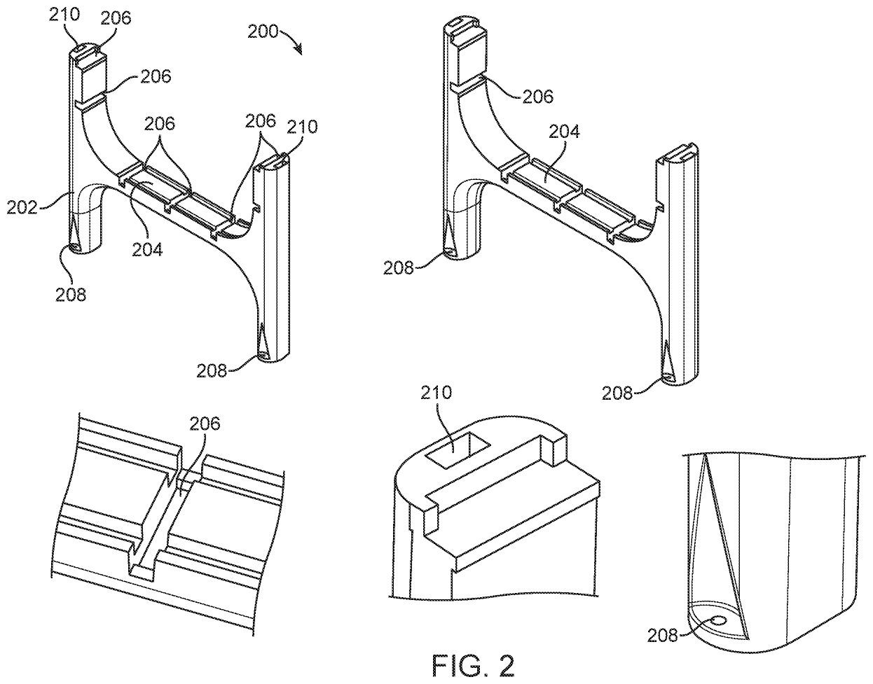

FIG. 2 illustrates a schematic representation 200 of the H-support 202, configured to provide support to the modular tank system 100, and showing enlarged view of grooves (204, 206) and holes (208, 210) present in the H-support designed for specific purposes.

The H-support 202 comprises pre-fabricated grooves (204, 206) for holding linear seal, lateral bars, locking bar and end-caps. The grooves 204 prefabricated in the H-support 202 provide linear mechanical support and mechanically locks the outer seal in place. The lateral bars lock in respective grooves (206) to make a rigid framework. The H-support 202 also comprises holes 208 at bottom to provide a mean to attach the modular tank system 100 to the ground or elevated if deemed necessary. The H-support 202, which is configured to connect consecutive modular tank assembly and transmits vertical forces from the liners and its content to the ground. The H-support 202 elevates the height of the modular tank system 100 to a healthy working height and provides space for piping under the modular tank system 100 for application in various industries. The H-support 202 also has a hole 210 over top of the H-support 202 for accommodating vertical supporting bars of green house and high plants frame support system. The hole 210 also acts as a locking mechanism for vertically stacking the modular tank system. The H-support 202 can be designed of any height as per needs of clients and users.

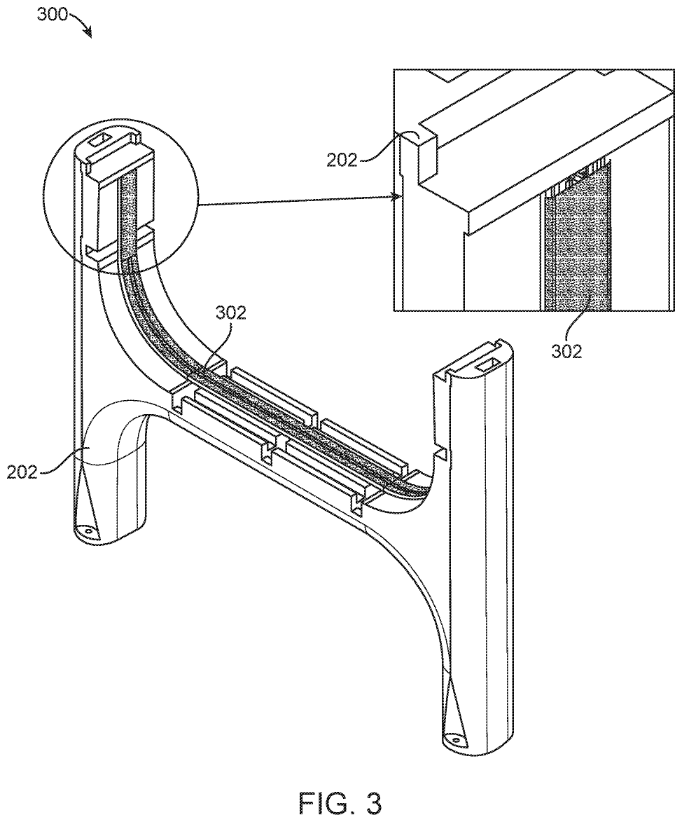

FIG. 3 illustrates a schematic representation 300 of side elevation view of the H-support 202 with an outer seal 302 and enlarged view of interlocking mechanism between the H-support 202 and the outer seal 302.

The H-support 202 comprising a groove 204 where the outer seal 302 is inserted to form a support structure and other components to form the modular tank system 100. Further showing enlarged view of the support structure where of the outer seal is interlocked within the grooves 204 of the H-support 202. The seal 302 is pushed in place and locks into the edges provided by the H-support 202.

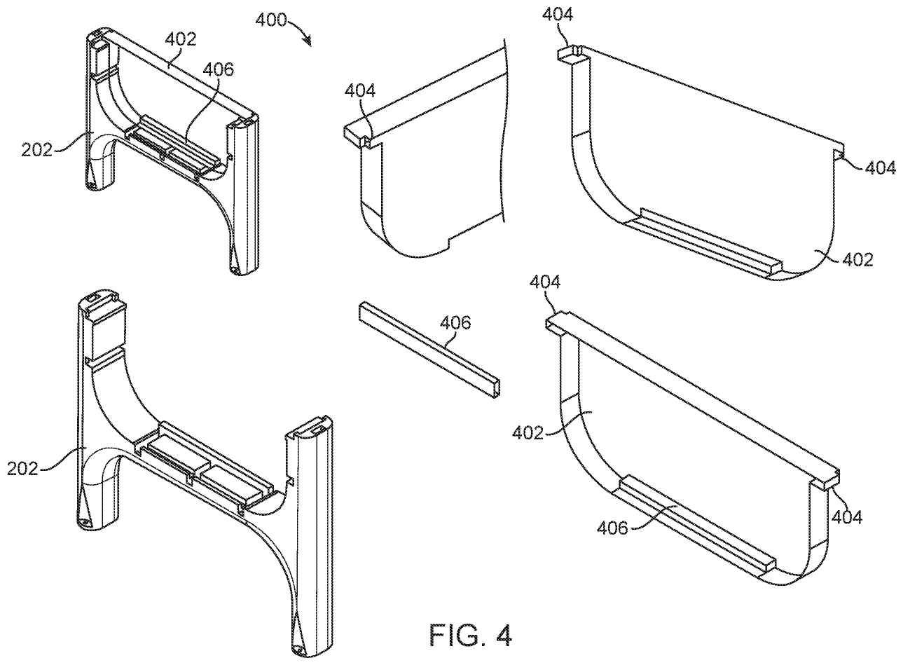

FIG. 4 illustrates a schematic representation 400 of an end-cap 402 configured to transmit lateral mechanical force to the H-support 202 and enlarged view of top-end clamping connectors 404 present in the end-cap 402 and a locking bar 406 which are interlocked within the grooves 206 of the H-support 202 and an interlocked structure of the end-cap 402 with the H-support 202.

The end-cap 402, which is configured to terminate the modular tank system 100 at respective ends. The end-cap 402 comprises pre-fabricated top-end clamping connectors 404, which locked inside the H-Support 202 fitted with a locking bar 406 for transmitting lateral mechanical force to the H-support 202 using 2 connectors on top and a locking bar 406 at the bottom, by simply sliding inside the H-Support 202. The end-cap 402 provides the same linear seal profile for the adjacent liner. The end-cap is light-weight for easy installation, transportation and can be customized as per the needs.

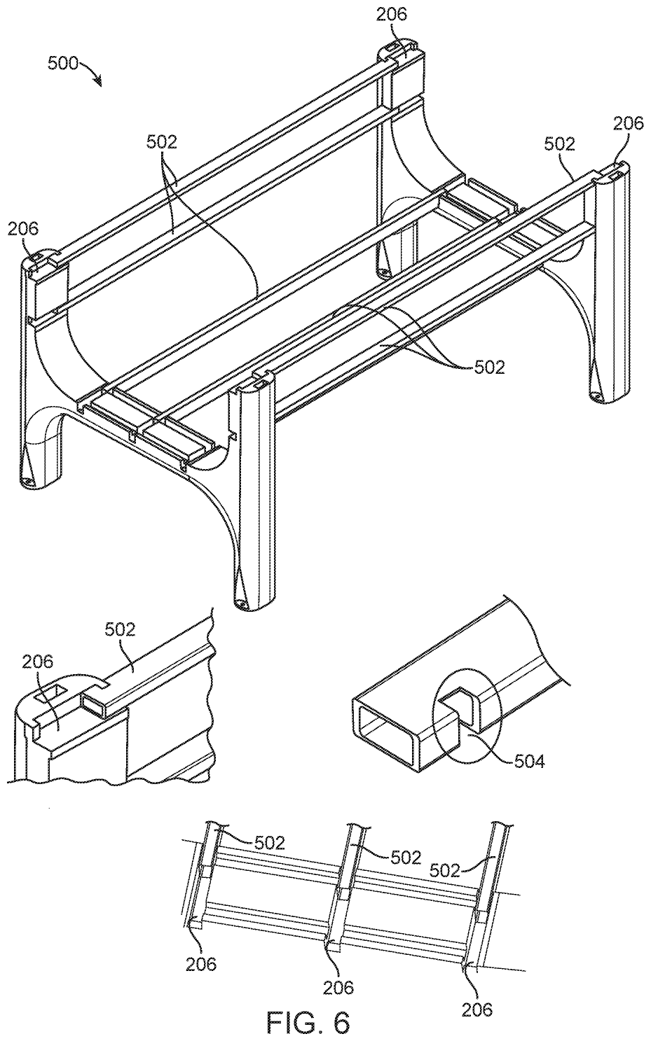

FIG. 5 illustrates a schematic representation 500 of side elevation view showing connection of multiple lateral bars 502 between the H-supports 202. Also showing detailed view of interlocking mechanism of lateral bar 502 between H-supports 202 and lateral bar interlocking aperture 504 present at both ends of the lateral bar 502.

The lateral bar 502 configured to transmit horizontal mechanical force between the H-supports 202 of the modular tank system 100. The lateral bar 502 also transmits vertical weight of the modular tank system 100 and its content to the H-support. The highly rigid lateral bars 502 maintain the integrity of the liner, which is further connected for forming the modular tank system 100. The lateral bar 502 also provides space and mechanical support for accommodating thermal insulation panels in the modular tank system 100.

The lateral bar 502 are specially designed and pre-fabricated for interlocking at both ends with the groove 206 present in the H-support 202 of the modular tank system 100.

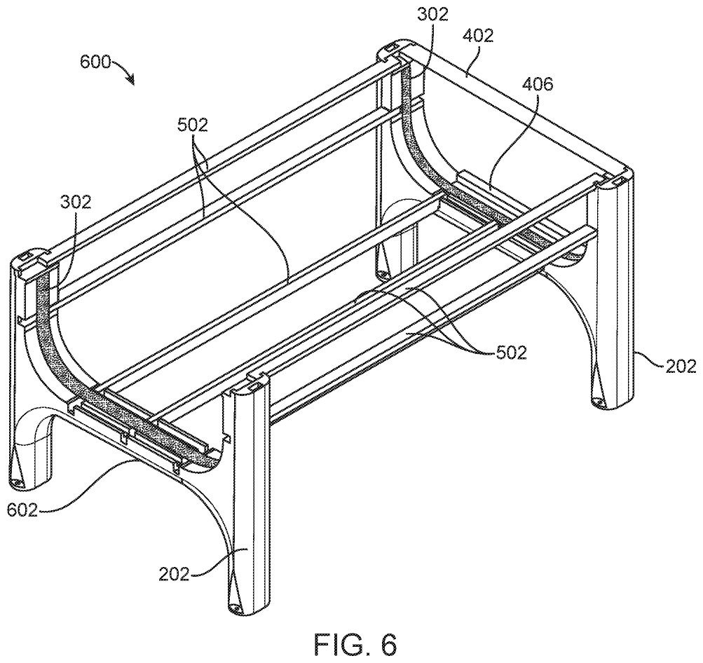

FIG. 6 illustrates a schematic representation 600 of a supporting structure 602 formed by connecting two H-supports 202 with each other using the lateral bars 502 of the modular tank system 100.

The supporting structure 602 is formed, by connecting the lateral bars 502 in between the H-supports 202, integrated with the outer seal 302 and the end-cap 402. The multiple lateral bars 502 are inserted in especially designed grooves 206 present in both the H-supports 202 to form an interlocked linkage between the H-supports 202. The supporting structure 602 formed can be further connected to each other in series to form a long and continuous table top like structure. The supporting structure 602 is further connected to other components to form the modular tank system 100.

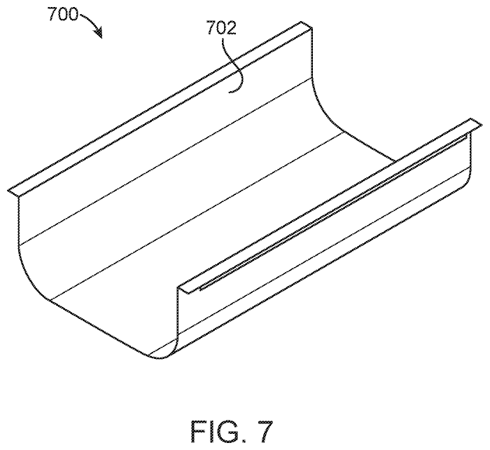

FIG. 7 illustrates a schematic representation 700 of liner 702, configured to hold intended content of the modular tank system 100.

The liner 702 is specially fabricated to accommodate the intended content of the modular tank system 100. The liner 702 provides a linear profile designed to accommodate the linear seal. The liners 702 are specially designed in such a way that they are stackable inside each other to optimize transportation process by minimizing total volume. The liner 702 can be manufactured in various sizes as per the requirements.

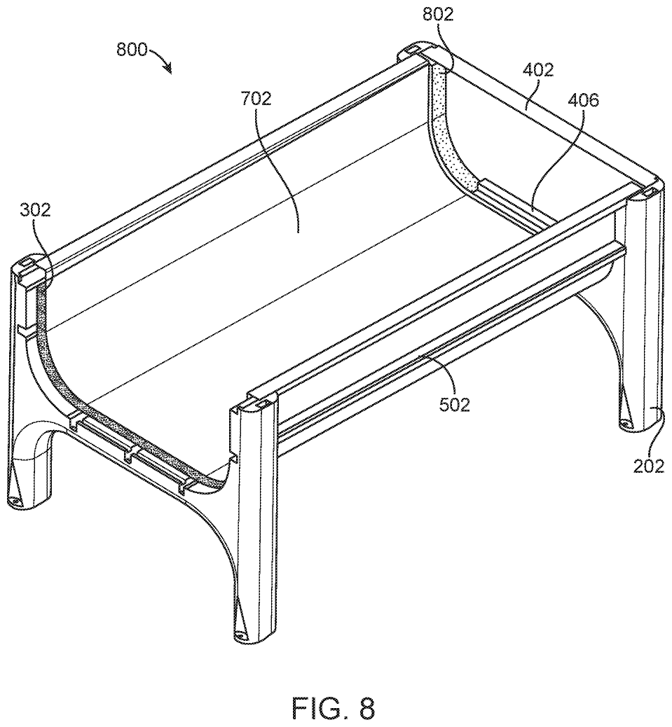

FIG. 8 illustrates a schematic representation of a single modular tank 800 without second end cap, comprising H-support 202 with outer seal 302, inner seal 802, end-cap 402, lateral bars 502 and liner 702, which are further connected in series to form a long and continuous profile modular tank.

The single modular tank 800 as shown in FIG. 8 without the second end cap 402 is formed by putting the liner 702 in place in FIG. 6 and further inserting the inner seal 802 over the liner 702. The outer seal 302, the H-support 202, the liner 702 and an inner seal 802 forms an integral structure, which maintains the mechanical and hydraulic integrity of the modular tank system 100. The single modular tank 800 as shown in FIG. 8 is assembled, by inserting the second end cap 402, the locking bar 406, clipping the second inner seal 802 over the second H-support 202 and the liner 702. The single modular tank 800 can be further connected in series to form a long and continuous profile tank of required length and as the required length is reached, the end cap 402 and the locking bar 406 is inserted to terminate the tank, and thus a long and continuous modular tank system 100 can be formed. Thus, providing an interlocked sealed assembly assuring mechanical and hydraulic integrity and thus, providing a leak-proof modular tank system 100.

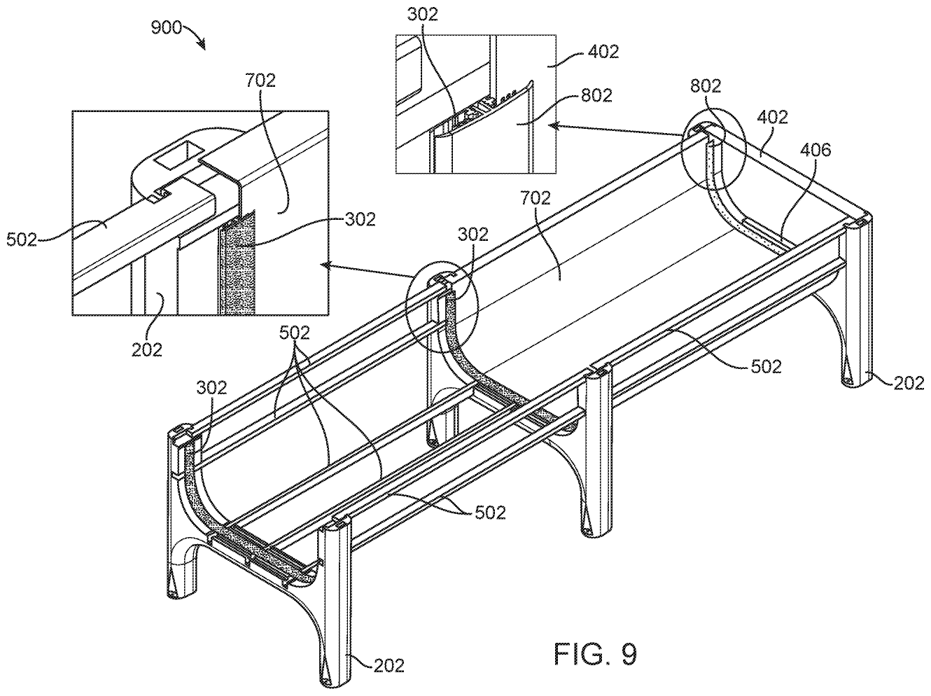

FIG. 9 illustrates a schematic representation of an enlarged view of consecutive connection between the single modular tank 800, interlocking mechanism between the H-support 202, and the lateral bars 502. Also showing clipping mechanism between the inner seal 802, the outer seal 302, the liner 702 and the end-cap 402.

Multiple lateral bars 502 are inserted in specially designed grooves 206 present in the H-support 202 and further connected to the single modular tank 800, as shown in FIG. 8, forming an interconnecting structure formed by single modular tank 800, H-support and multiple lateral bars 502. The multiple lateral bars 502 are connected in the corresponding grooves configured in the H-support 202 for holding the lateral bars 502.

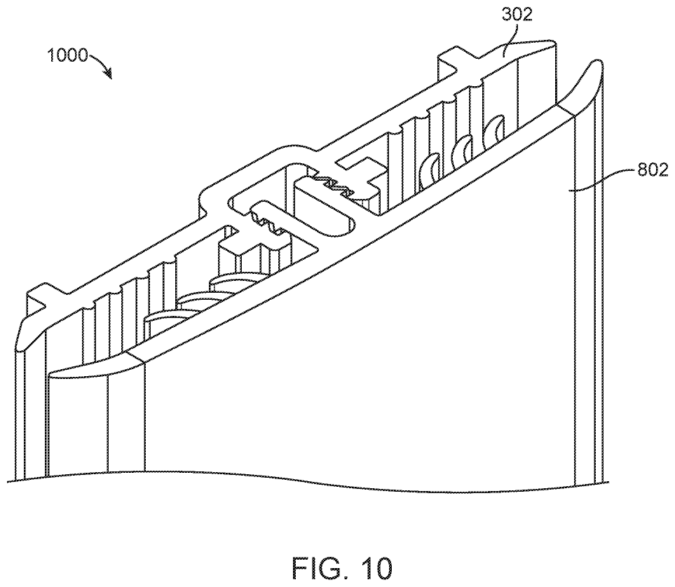

FIG. 10 illustrates a schematic representation of top sectional view of the linear seal 1000 consists of the outer seal 302, the inner seal 802 and interconnection between the outer seal 302 and the inner seal 802 of the modular tank system 100.

The linear seal 1000 is flexible and self-adjusting two part seal consists of the outer seal 302 and the inner seal 802, which is designed for sealing two flat surfaces. The linear seal 1000 consists of the outer seal 302 and the inner seal 802, configured to fit in the H-supports 202 and assure hydraulic seal between two liners 702 or between an end-cap 402 and a liner 702.

The outer seal 302 is featuring a female mechanical connector designed to connect to the male inner seal connector, a set of half o-ring soft seals and a soft edge lip seal designed to seal on the outside surface of liner 702 or an end cap 402. The outer seal 302 also features flexible rubber on each sides of the female connector designed to space two liners 702 or an end-cap 402 and a liner 702.

The inner seal 802 features as multiple soft fin seals and an edge lip seal designed to seal on the inner surface of a liner 702 or an end-cap 402. The inner seal 802 features a central male part that is designed to lock inside the outer seal female central part and maintain the two parts of the seal strongly mechanically connected together.

The fin-connectors of the outer and inner seal mechanical male and female connectors locks together linearly under thumb pressure. The self-adjusting soft rubber material of the half o-rings, fins, and edge lips seals featured in the outer seal 302 and inner seal 802 are designed to accommodate the sealing surface irregularities of the liner 702 and the end-cap 402. The linear seal 1000 is flexible enough for accommodating the radius of the H-support 202, the liner 702 and the end-cap 402. The self-adjusting and flexible linear seal 1000 can be designed for any thickness. The linear seal 1000 is designed to be versatile and flexible that the linear seal 1000 could be used in any other applications ensuring linear hydraulic sealing between two flat surfaces.

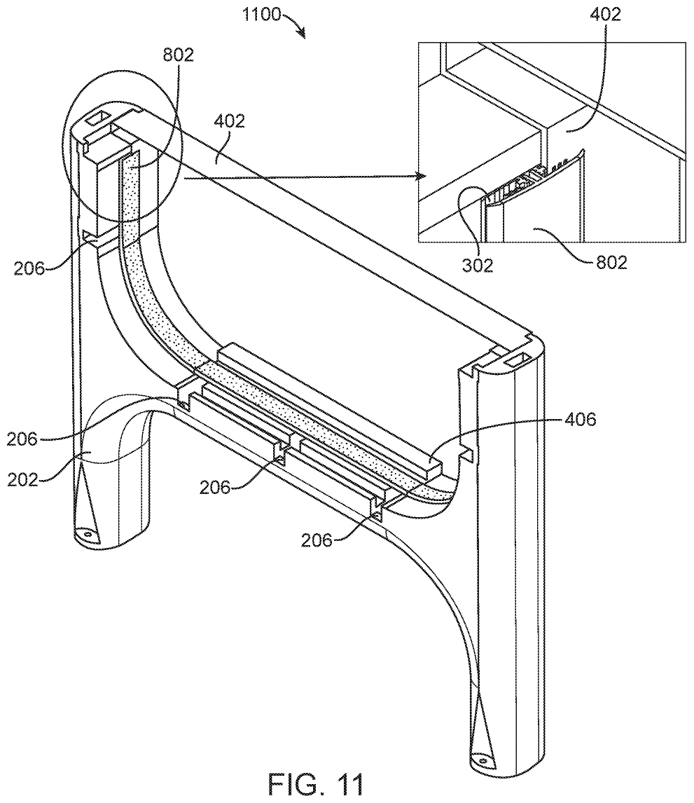

FIG. 11 illustrates a schematic representation 1100 of detailed view of the H-support 202 with the end-cap 402, the outer seal 302, the locking bar 406 and the inner seal 802 placed in respective positions.

The H-support 202, the outer seal 302, the end-cap 402 and the inner seal 802 forms an interlocked sealed assembly assuring mechanical and hydraulic integrity and thus, providing the leak-proof modular tank system 100. The back side of the outer seal 302 is firstly lined up inside the H-support 202, then the locking bar 406 and the end-cap 402 is inserted in respective grooves. The inner seal 802 is placed above the outer seal 302 which provides external hydraulic seal using the self-adjusting flexible half rubber o-rings and edge lip seal in the outer seal 302. Further, the sealing fins and edge lip seal featured in the inner seal 802 forms a hydraulic sealing assembly with a liner 702 or an end-cap 402.

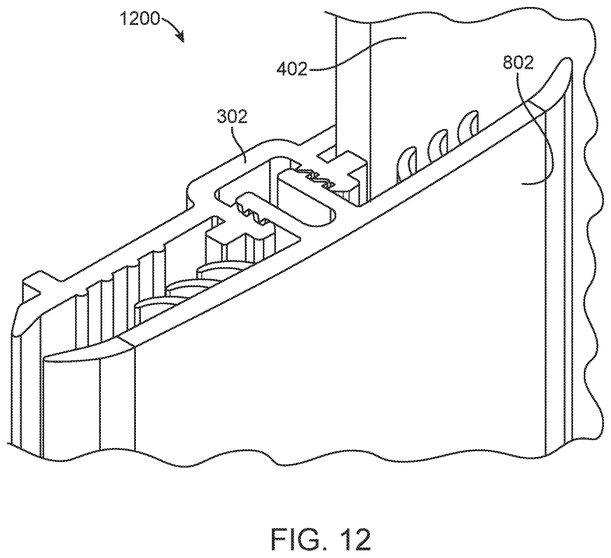

FIG. 12 illustrates a schematic representation 1200 of sectional top view of interconnecting clipping mechanism between the outer seal 302 and the inner seal 802 of the modular tank system 100.

The self-adjusting flexible half rubber o-rings and edge lip seal featured in the outer seal 302 and the self-adjusting flexible fins and edge lip seal featured in the inner seal 802 fit inside in the space provided for the outer seal 302 and the inner seal 802 in the liner 702. The liner 702 gets fitted within the rectangular linear spacer of the outer seal 302 and edge lip seal featured in the inner seal 802. The inner seal 802 features a central male part that is designed to lock inside the outer seal female central part and maintain the two parts of the seal strongly mechanically clip together to form an interlocked joined structure maintaining mechanical and hydraulic integrity of the modular tank system 100.

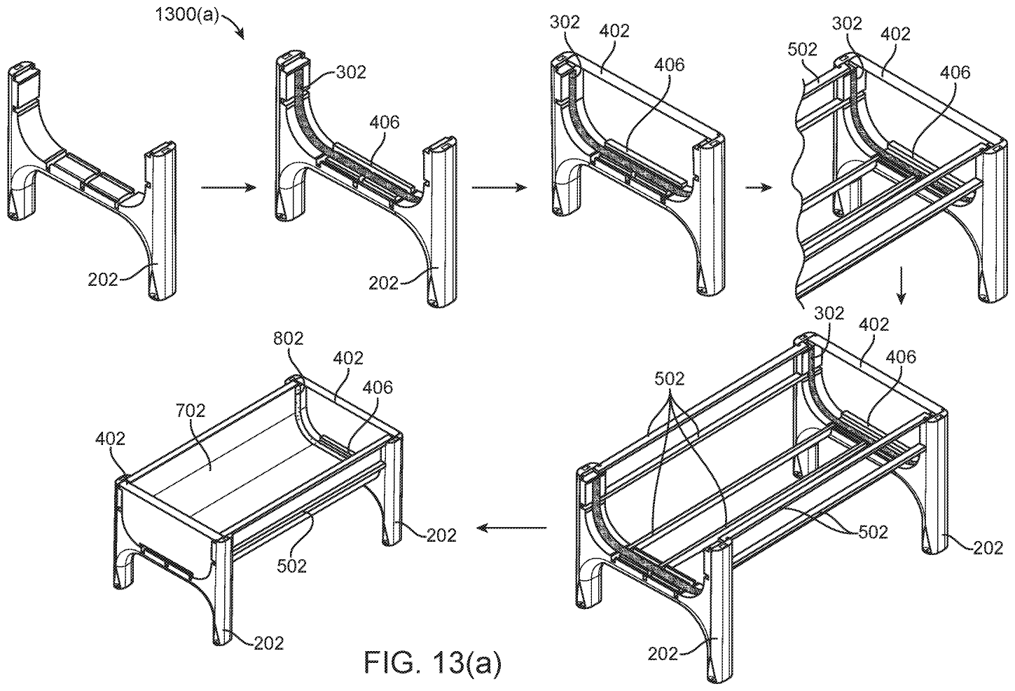

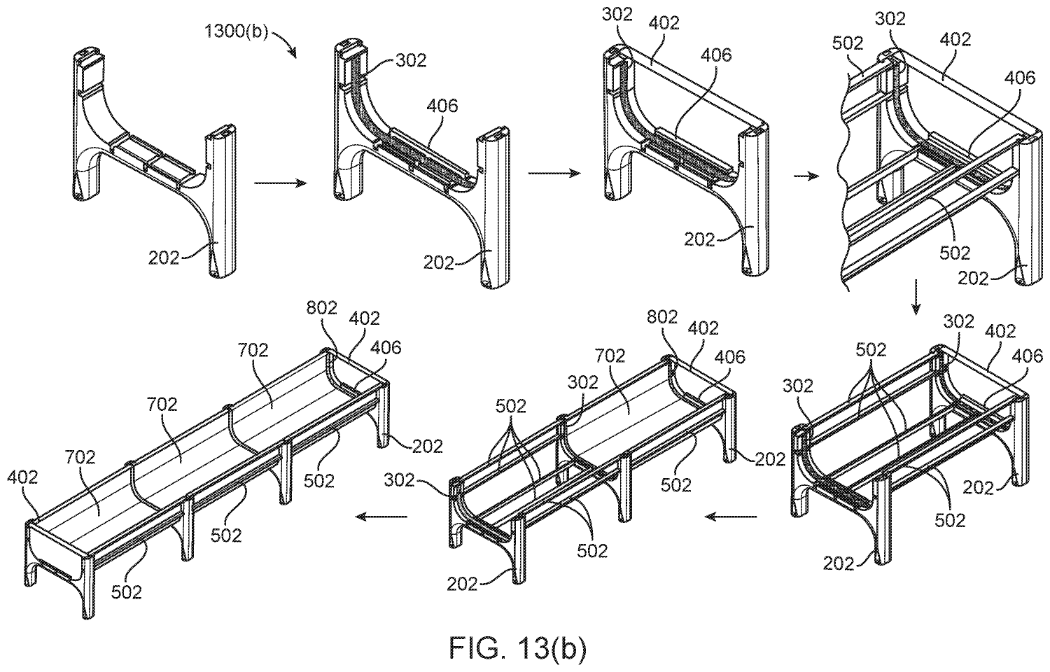

FIG. 13 (a) illustrates a schematic representation of fully comprehensive step-by-step details of the method of assembling the single modular tank 800.

Embodiment in accordance with the present invention and referring to FIG. 13 (a), a method of assembling the single modular tank is described herein. The method includes putting the outer seal 302 inside the outer-seal groove 204 of first H-support 202. The backside of the outer seal 302 lays inside the H-support 202, as shown in FIG. 3 and each end of the outer seal 302 locks in the edges located on top of the H-support. Further, the method includes a locking bar 406 inside the horizontal rectangular groove of the H-support 202 and further sliding the end-cap 402 in the first H-support 202 with the outer seal 302 in place. The pre-fabricated top-end clamping connectors 404 locks inside the grooves of the H-Support 202 transmitting the lateral mechanical force to the H-support 202, as shown in FIG. 4. The method further includes placing a second H-support in place and inserting multiple lateral bars 502 between the first H-support 202 where the outer seal 302 and end-cap 402 are in place and the second H-support. The grooves 206 present in the H-support 202 gets interlocked with the pre-fabricated interlocking aperture in the lateral bar 502, as shown in FIG. 5. The method further includes fitting an outer seal 302 in place in the second H-support 202. The pre-fabricated interlocking aperture 504 present at the other end of the lateral bar 502 gets interlocked with the second H-support 202, and thus forming integral supporting structure 602, as shown in FIG. 6. The method further includes putting the liner 702 in place in the integral supporting structure 602. The liner 702 is placed above the outer seal 302 of the first H-support 202, on top of the half O-ring seals and against the rectangular rubber part featured in the outer seal 302. Further, the inner seal 802 is clipped into the outer seal above the liner 702 by applying thumb pressure over it. The fins and edge lip seal featured in the inner seal 802 forms a sealing assembly with the liner 702 as shown in FIG. 8. The method further includes sliding the second end-cap 402 and second locking bar 406 in the second H-support 202. Further, an inner seal 802 is clipped above the outer seal 302 and the liner 702 by applying thumb pressure over it and thus, forming a single modular tank.

FIG. 13 (b) illustrates a schematic representation of fully comprehensive step-by-step details of the method of assembling of the long profile modular tank system.

Embodiment in accordance with the present invention and referring to FIG. 13 (b), a method of assembling the modular tank system 100 is described herein. The method includes putting the outer seal 302 inside the outer-seal groove 204 of first H-support 202. The backside of the outer seal 302 lay inside the H-support 202, as shown in FIG. 3. Further, the method includes sliding a locking bar 406 inside the horizontal rectangular groove of the H-support 202 and further sliding the end-cap 402 in the first H-support 202 with the outer seal 302 in place. The pre-fabricated top-end clamping connectors 404 and locks inside the grooves of the H-Support 202 transmitting the lateral mechanical force to the H-support 202, as shown in FIG. 4. The method further includes placing a second H-support in place and inserting multiple lateral bars 502 between the first H-support 202 where the outer seal 302 and end-cap 402 are in place and the second H-support. The grooves 206 present in the H-support 202 gets interlocked with the pre-fabricated interlocking aperture in the lateral bar 502, as shown in FIG. 5. The method further includes attaching the second H-support 202 with the outer seal 302 fixed in place with the first H-support 202 with the outer seal 302 and multiple lateral bars 502 in place. The pre-fabricated interlocking aperture 504 present at the other end of the lateral bar 502 gets interlocked with the second H-support 202, and thus forming integral supporting structure 602 as shown in FIG. 6. The method further includes putting the liner 702 in place in the integral supporting structure 602. The liner 702 is placed above the outer seals 302 of each H-support 202, providing an outer seal on the external surface of the liner and self-adjusting flexible half rubber o-rings and edge lip seal featured in the outer seal 302. Further, the inner seal 802 is clipped above the liner 702 and end cap 402 by applying thumb pressure over its central area. The fins and edge lip seal featured in the inner seal 802 forms a sealing assembly with the liner 702, as shown in FIG. 8. The method further includes sliding the second end-cap 402 and second locking bar 406 in the second H-support 202. Further, an inner seal 802 is clipped above the outer seal 302 and the liner 702 by applying thumb pressure over it and thus, forming a single modular tank, as shown in FIG. 13 (a), in detail. The method further includes increasing the length of the modular tank system simply by removing the second end-cap 402 and the inner seal 802 and further adding the H-supports 202, the outer seal 302, the multiple lateral bars 502, the liner 702 and the inner seal 802 in respective positions to the single modular tank consecutively in series. The method further includes inserting the second end-cap 402 and second locking bar 406 in the last H-support 202 after the required length is attained. The method further includes clipping the inner seal 802 over the outer seal 302 of the last H-support 202 to form a modular tank system of required length and specifications.

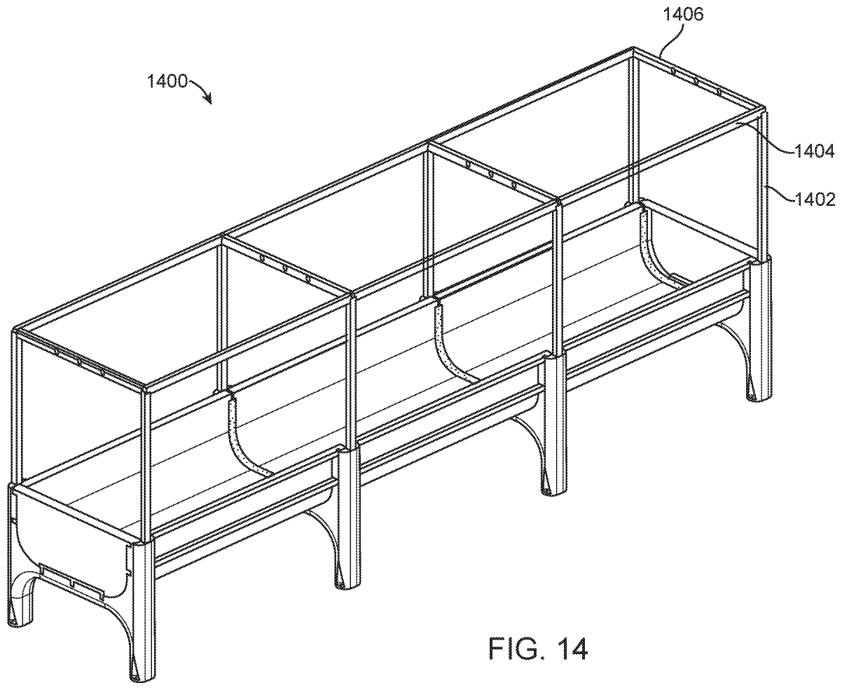

FIG. 14 illustrates a schematic representation 1400 of the modular tank system 100 fitted with an integrated greenhouse support system comprising 3-part interlocking bars connected with vertical supporting bar 1402, transversal supporting bar 1404, lateral supporting bar 1406 for mechanical support of tall plants.

The modular tank system 100 used as an integrated green house system for supporting growth of the tall plants comprising modular tank system 100, 3-part interlocking bar system and supporting bars. The 3-part interlocking bar system comprising vertical supporting bar 1402, transversal supporting bar 1404 and lateral supporting bar 1408 interlocked with each other forming an integral mechanical green house supporting structure supporting plastic film and mechanical support for plants. The vertical supporting bar 1402 is inserted in the H-support 202 of the modular tank system 100. Further, the transversal supporting bar 1404 is attached with the vertical supporting bar 1402 and the lateral supporting bar 1406 is further attached to the vertical supporting bar 1402 and the transversal supporting bar 1404 and thus, forming the 3-part interlocking bar system. The lateral supporting bar 1406 is also provided with the holes for inserting other supporting bars and sprinkler pipe to provide further support to the green house supporting structure. The numbers of the vertical supporting bar 1402, transversal supporting bar 1404, lateral supporting bar 1406 of the 3-part interlocking bar system is decided as per the length of the modular tank system 100.

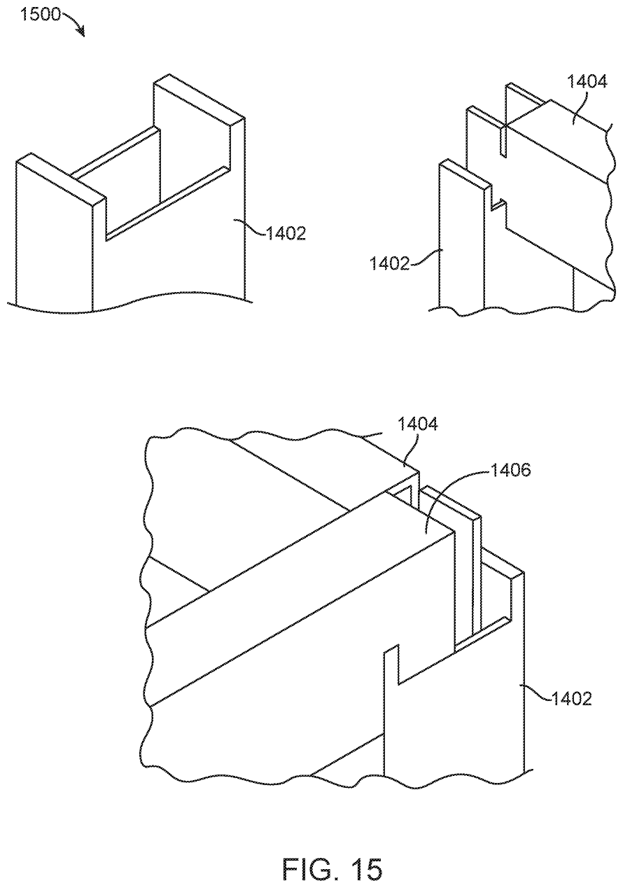

FIG. 15 illustrates a schematic representation 1500 of detailed view of the 3-part interlocking bar system comprising the vertical supporting bar 1402, the transversal supporting bar 1404 and the lateral supporting bar 1406 and enlarged view of interlocked structure formed by the vertical supporting bar 1402, the transversal supporting bar 1404 and the lateral supporting bar 1406 of the 3-part interlocking bar system.

The 3-part interlocking bar system comprising the vertical supporting bar 1402, the transversal supporting bar 1404 and the lateral supporting bar 1406 interlocked with each other forming an integral mechanical green house supporting structure supporting growth of plants. Further analyzing the detailed view of the vertical supporting bar 1402 of the 3-part interlocking bar system, it is comprehend that the vertical supporting bar 1402 comprises an interlocking groove at its top end at which the transversal supporting bar 1402 gets interlocked via its interlocking aperture and further, the lateral supporting bar 1406 is attached at the interlocking structure formed by the vertical supporting bar 1402 and the transversal supporting bar 1404. The vertical supporting bar 1402, the transversal supporting bar 1404 and the lateral supporting bar 1406 of the 3-part interlocking bar system forms an interlocked structure at the respective points of attachment of the green house supporting structure.

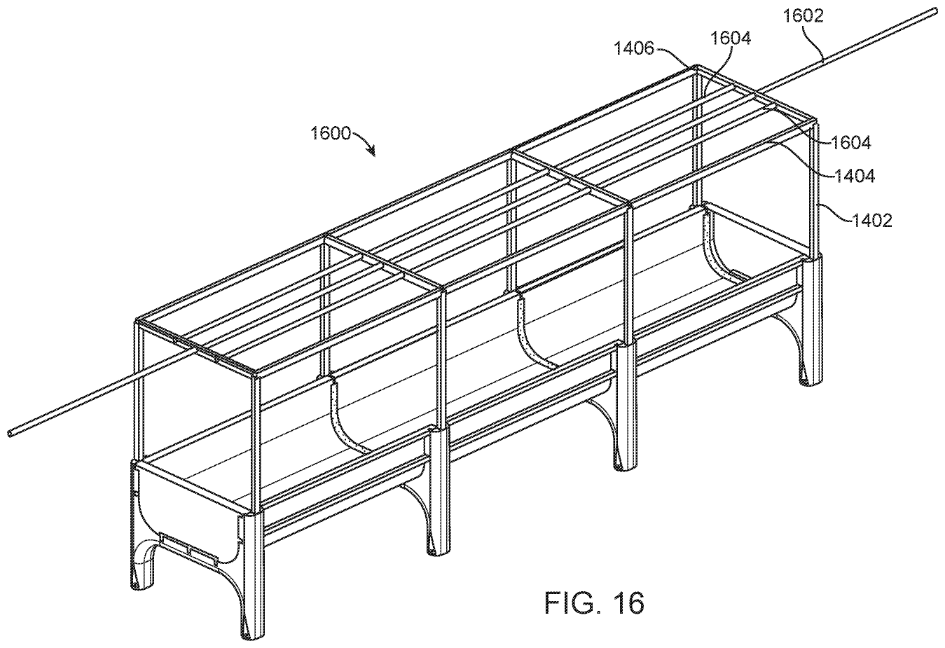

FIG. 16 illustrates a schematic representation 1600 of the modular tank system 100 used as an integrated green house system with sprinkler system comprising, 3-part interlocking bar system attached with the vertical supporting bar 1402, the transversal supporting bar 1404 and the lateral supporting bar 1406, a sprinkler pipe 1602 and one or more supporting bars 1604 is inserted in the holes provided in the lateral supporting bar 1406 of the 3-part interlocking bar system. The length of the sprinkler pipe 1602 and other supporting bars 1604 is selected according the length of the modular tank system 100.

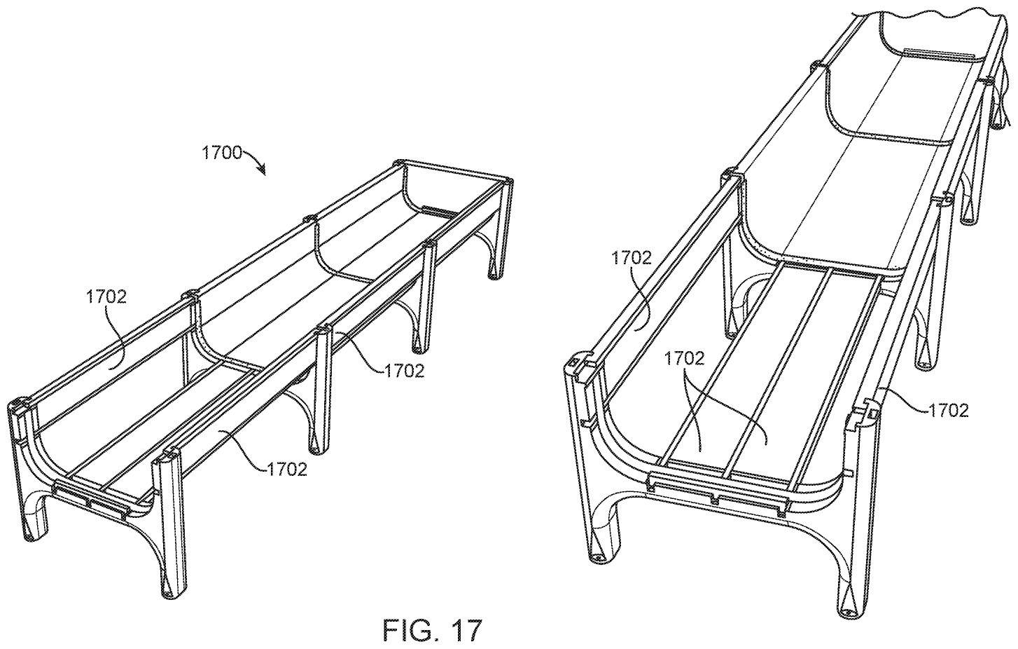

FIG. 17 illustrates a schematic representation of the 1700 modular tank system 100 fitted with an insolation system comprising thermal insulation panels 1702 squeezed between the lateral bars 502 in the modular tank system 100.

The modular tank system 100 is fitted with multiple thermal insulation panels' 1702 preventing heat exchange between the content of the tank and the atmosphere, maintaining the content of the tank at constant temperature.

In exemplary embodiment of the present invention, the modular tank system 100 is utilized for raising aquatic animals such as but not limited to fish, snails, crayfish or prawns for the aquaponics system. Depending on the climate where the aquaponics system is located, and the type of aquatic animals being raised, it may be necessary to maintain the temperature of the water in the modular tank system 100. The multiple thermal insulation panels 1702 are inserted in the modular tank system 100 to provide a thermal insulation preventing a temperature variation of the fluid contained in the modular tank system 100. The more effective the insulation, the easier it is to maintain a consistent temperature of the water in the modular tank system 100. In cold environment, the thermal insulation reduces the energy costs otherwise incurred in heating the water. The temperature range for the best overall production and least stress of aquatic animals is between about 78 to 80 degrees F. In this restricted temperature range, the aquatic animals eat the greatest amount of food and convert it to protein with little or no stress. If the temperature is too high, the oxygen requirements go up dramatically, and if the temperature is too low, the aquatic animals slow down and do not convert food into protein efficiently.

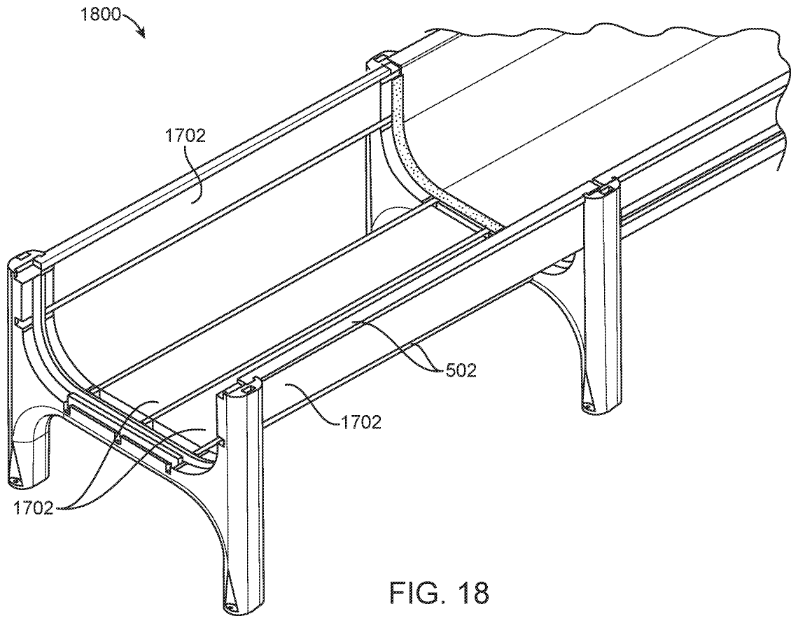

FIG. 18 illustrates a schematic representation 1800 of detailed view of the modular tank system 100 fitted with thermal insulation panels 1702 to prevent heat exchange between the tank content and the atmosphere as shown in FIG. 17.

By perusing the FIG. 17 in detail, it is interpreted that the thermal insulation panels 1702 are placed in between the lateral bars 502 in the modular tank system 100. In an exemplary embodiment, the side and bottom thermal insulation panels 1702 are installed by squeezing the thermal insulation panels 1702 in between the respective lateral bars 502. The thermal insulation panels 1702 are squeezed in between the lateral bars and placed in such a manner to provide maximum thermal insulation.

The number or thickness of the thermal insulation panels 1702 depends entirely on the requirement of the user and area of application of modular tank system 100. The size of the thermal insulation panels 1702 depends on the size of lateral bars 502 and distance between the two lateral bars 502.

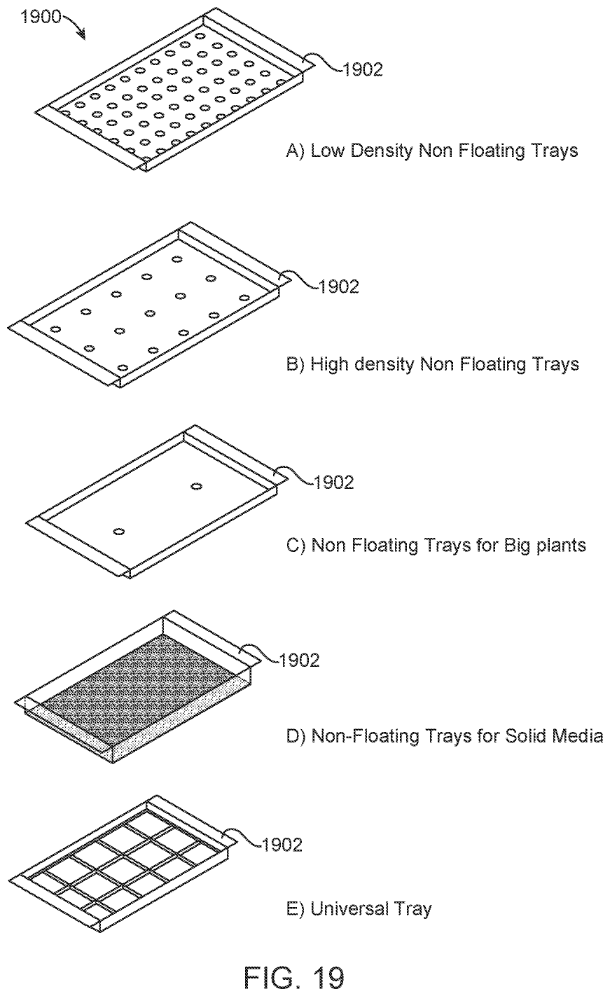

FIG. 19 illustrates a schematic representation 1900 of various options of the non-floating trays 1902 used for holding the plants in the modular tank system 100.

The non-floating trays 1902 are self-supporting trays, which are mechanically supported by the modular tank system 100. In an exemplary embodiment of the present invention, the modular tank system 100 utilized as aquaponics system for growing plants, vegetables etc. The non-floating trays 1902, by mechanically supporting the pots independently of the water level, enables an adjustable oxygenating air gap on the top roots of the growing plants close to the pots, also keeping the pots dry. The water level in the modular tank system 100 is regulated, by adjusting the length of the draining standpipe 2102. The non floating trays 1902 which are designed for growing different types of plants according to plants size and type of plants grown such as but not limited to vegetables, green leafy vegetables, long plants, fruits etc. The non-floating trays 1902 can be designed with various density and size of holes, and also can be filled with growing media for supporting the growth of the plants. The several types of non floating trays 1902 designed are low density non floating trays, high density non floating trays, non floating trays for big plants, non floating trays for solid media and universal non floating trays designed for holding a flat board configured as required for any specific plant holding technique.

The non-floating tray 1902 featuring holes to hold pots may be manufactured based on the size of the plants the user aims to grow. In high density (a lot of holes closed to each other) or in low density for more space between plants. It can also be designed to hold grow media such as gravel or hydroton. The modular tank system 100 is also compatible with other types of trays such as floating trays.

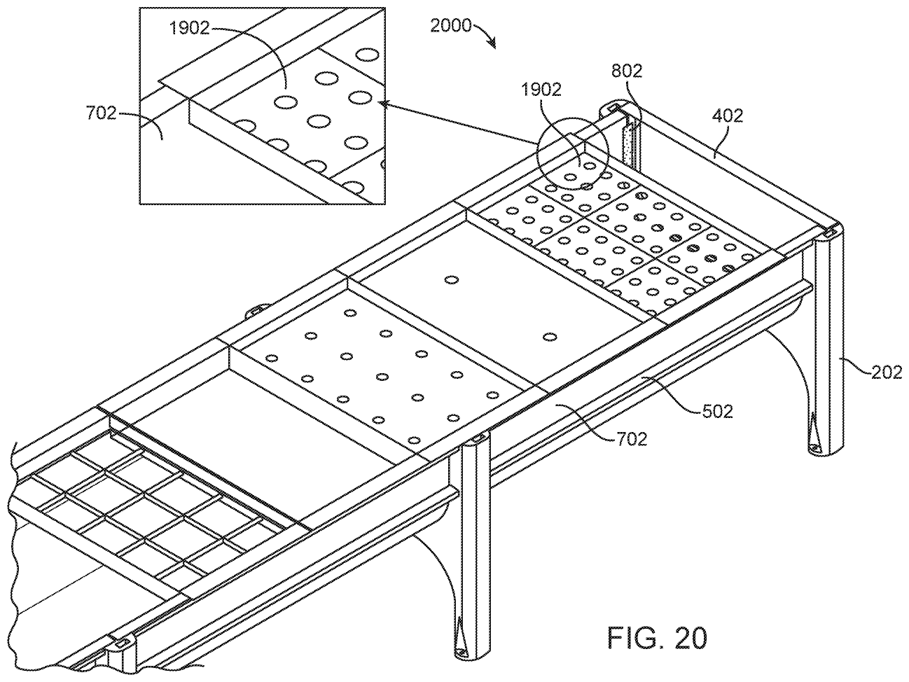

FIG. 20 illustrates a schematic representation of modular tank system 100 with non-floating trays 1902 and enlarged view showing placement of non-floating trays 1902 in the modular tank system 100.

The non-floating trays 1902 trays are placed on top of the liner 702 of the modular tank system 100. Detailed view of FIG. 20 is showing, that the uplifted part of the non-floating tray 1902 mechanically supported on the liner 702 of the modular tank system 100. The liner holds the non-floating trays 1902 tightly over its surface and makes the trays stable over the modular tank system 100.

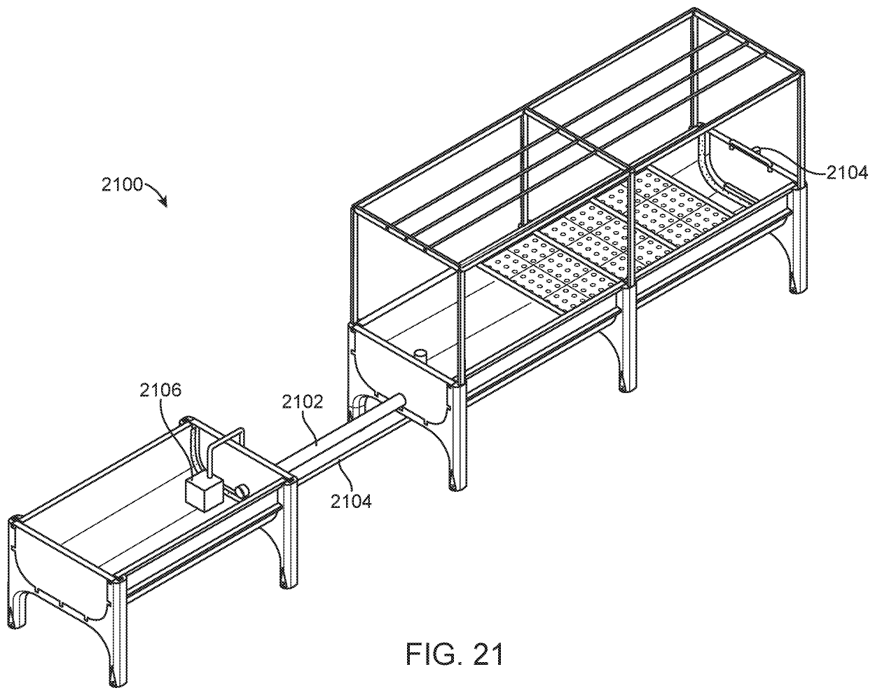

FIG. 21 illustrates a schematic representation 2100 of the modular tank system 100 utilized as aquaponics system comprising, non floating trays 1902, 3-part interlocking bar system, sprinkler pipe 1602, supporting bars 1604, and a single modular tank fitted with a pump 2106 and piping assembly configured to interconnect both the tanks of the aquaponics system.

Embodiment in accordance with the present invention and referring to FIG. 21, the modular tank system 100 utilized as the aquaponics system for growing plants, flowers, or vegetables etc is described herein. The aquaponics system comprising the modular tank system 100 configured to contain support medium required for growing plants, the non floating trays 1902 for holding the growing plants, the second modular tank system 100 configured for raising aquatic animals such as but limited to fish, snails, crayfish or prawns etc, filtration system for cleaning water leaving from the second modular tank system 100. The pump 2106 is configured to pump water from the second modular tank system 100, and piping assembly for interconnecting and circulating water between the two modular tank system 100.

The piping assembly consist of outer pipe 2102 which is configured to carry return water from the modular tank system 100 holding plants to the second modular tank 100 used for raising aquatic animals and inlet pipe 2104 configured to carry filtered water from the modular tank 100 used for raising aquatic animals to the modular tank system 100 holding plants for providing nutrients for growing the plants.

In an exemplary embodiment of the present invention, the modular tank system 100 utilized as the media filled aquaponics system for growing fruiting plants is described herein. The seedlings are placed in trays on the modular tank system 100. The water from the second modular tank 100 configured for raising aquatic animals is directly transferred to the modular tank system 100 configured to hold plants through the inlet pipe 2104 of the piping assembly and excess water is carried out through the outlet pipe 2102 and again re-circulated.

In one exemplary embodiment of the present invention, the modular tank system 100 is utilized as the DWC aquaponics system for growing herbs and leafy green vegetables with bigger root systems and fruiting varieties. In DWC aquaponics system, the plants are held in holes in non-floating trays 1902 and their roots are dangled down into the water filled in the modular tank system 100 configured for holding plants. The water from the second modular tank 100 configured for raising aquatic animals is firstly filtered through filtration system such as but not limited to mechanical filters, bio filters etc., to remove any solid wastes and the filtered water is pumped continuously to the modular tank system 100 configured for holding the plants. The pump 2106 further supplies filtered water through the inlet pipe 2104 to the modular tank system 100 configured for holding plants filled with supporting media such as but not limited to expanded clay pebbles, gravel, perlite, hydroton etc. Further, the excess water is carried out through the outlet pipe 2102 and again re-circulated in the DWC aquaponics system.

The aquaponics system also further comprising an optional provision for installing the 3-part interlocking bar system comprising vertical supporting bar 1402, transversal supporting bar 1404 and lateral supporting bar 1406 and for supporting the growth of tall plants and providing strength to growing tall plants. The sprinkler pipe 1602 and other supporting bars 1604 can also be optionally installed in aquaponics system for supplying water to the growing plants.

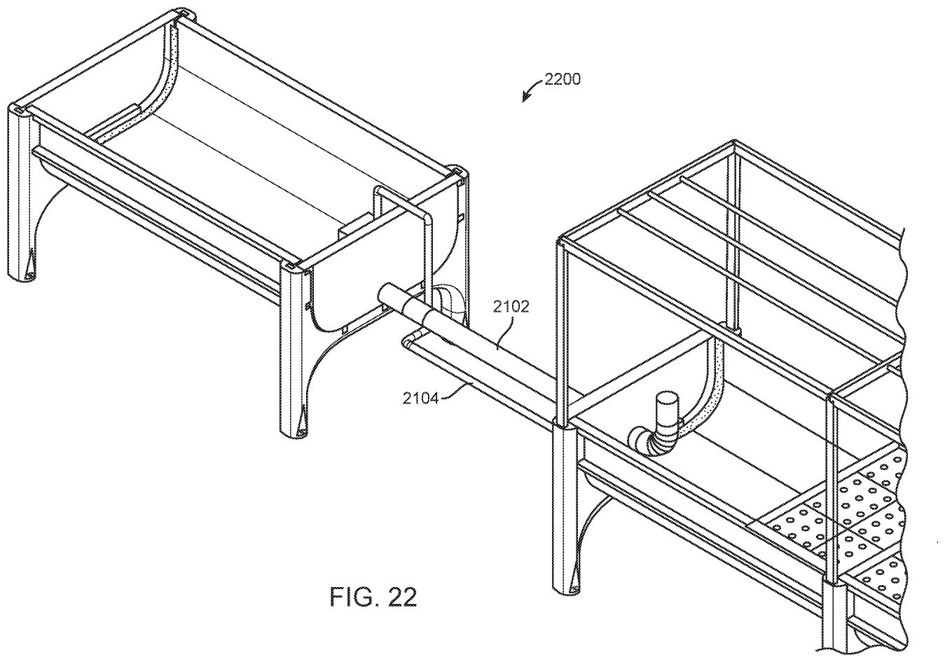

FIG. 22 illustrates a schematic representation 2200 of sectional and detailed view of piping assembly comprising outlet pipe 2102 and inlet pipe 2104 interconnecting both the modular tank system 100 of aquaponics system as shown in FIG. 21.

The piping assembly comprising outlet pipe 2102 interconnecting both the modular tank system 100 of the aquaponics system. The outlet pipe 2102 is configured to carry excess water from the modular tank system 100 configured to hold the plants.

The inlet pipe 2104 of the piping assembly interconnects both the modular tank system 100 of the aquaponics system. The inlet pipe is configured to carry filtered water pumped through pump to the modular tank system 100 configured to hold the plants of the aquaponics system. The inlet pipe 2104 is installed beneath the modular tank system 100 configured to hold the plants and clamped at respective H-support 202 of the modular tank system 100 configured to hold the plants and further inserted to the modular tank system 100 configured to hold the plants through the end-cap 402 adapted to secure the inlet pipe 2104 of the piping assembly.

In order to maintain constant water flow between and maintaining predetermined water level in both the modular tank system 100, the water can be periodically exchanged by continuously supplying the constant flow of filtered water from the inlet pipe into the modular tank system 100 configured for holding the plants and discharging excess water through the outlet pipe 2102 of the piping assembly and then further again filtered and re-circulated between both the modular tank system 100.

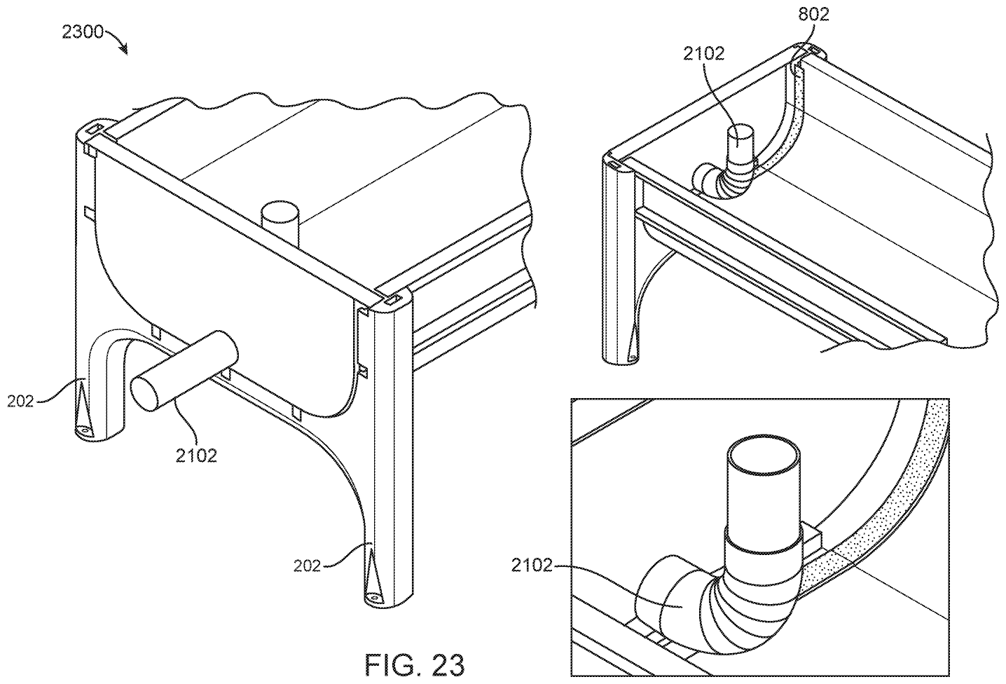

FIG. 23 illustrates a schematic representation side elevation and inner view of the modular tank system 100 set up as aquaponics system depicting the connection of the outlet pipe 2102 through the end-cap 402 and position of the outlet pipe 2102 of the piping assembly inside the modular tank system 100 configured to hold the plants of the aquaponics system as shown in FIG. 21.

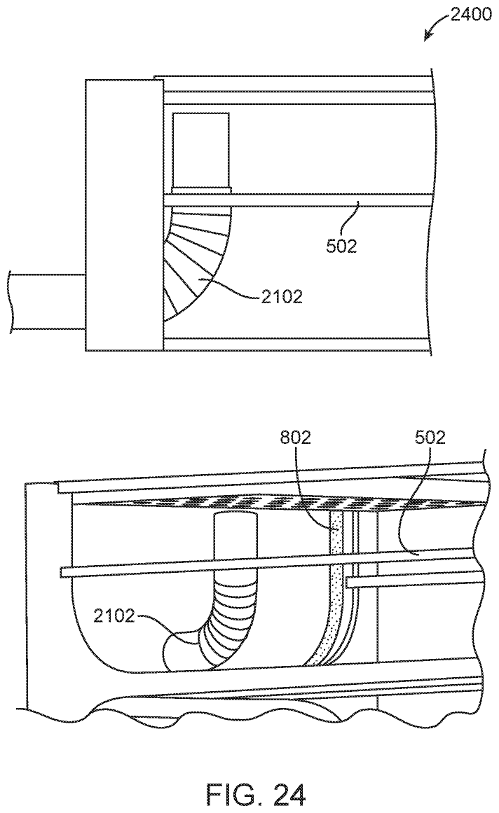

The end-cap 402 or the liner 702 of the modular tank system 100 may be modified for receiving the outlet pipe 2102 of the piping assembly or the automatic siphon. An elbow connects this outlet pipe 2102 to a straight vertical portion or a stand pipe whose length can be adjusted to control the water level in the tank as described in FIG. 24 illustrates a schematic representation 2400 of inner sectional view of the modular tank system 100 showing water level adjustments in the modular tank system 100 by changing the length of straight vertical portion of the outlet pipe 2102 of the piping assembly.

Further considering the FIG. 24 in detail, it is understood that the water level in the modular tank system 100 configured to hold the plants is adjusted by changing the length of the stand pipe connected to the outlet pipe 2102 of the piping assembly, thereby constantly providing an adequate amount of water for plants grown in the non floating trays 1902 in the modular tank system 100. The non-floating trays 1902 remain at same place and only the water level changes for different phases of root and plant development for growing plants.

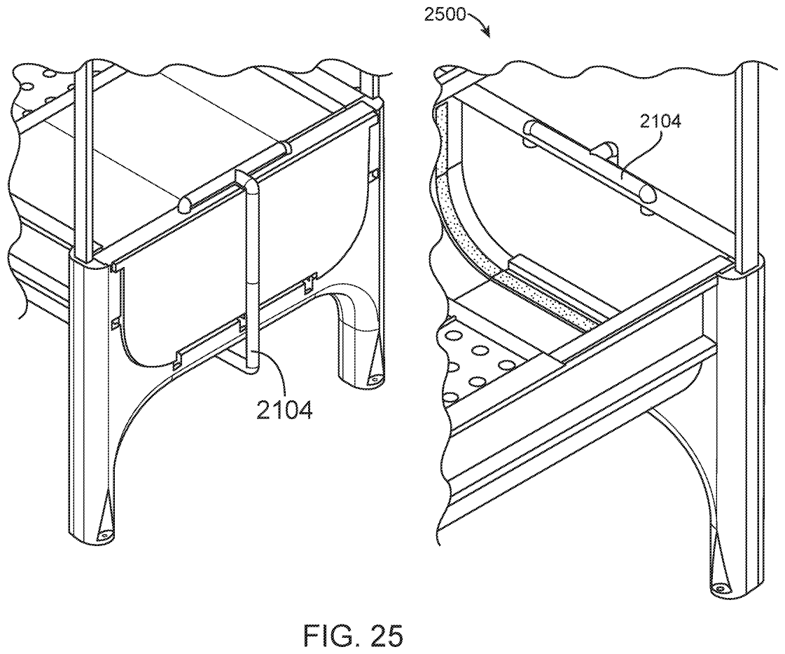

FIG. 25 illustrates a schematic representation 2500 of outer view and side view of the modular tank system 100 configured to hold the plants of the aquaponics system depicting inlet pipe 2104 of piping assembly carrying filtered water in the modular tank system 100 configured to hold the plants and which is further bifurcated and inserted on top of the end-cap 402 of modular tank system 100. The inlet pipe 2104 is installed beneath the modular tank system 100 configured to hold the plants and clamped at respective H-support 202 the modular tank system 100 configured to hold plants, as shown in FIG. 22, is further bifurcated in two parts and inserted over the end-cap of modular tank system 100.

The end-cap 402 of the modular tank system 100 contains the openings for inserting the inlet pipe 2104 which may be in form of holes, perforations, aperture, cleft etc. for receiving the inlet pipe 2104 of the piping assembly.

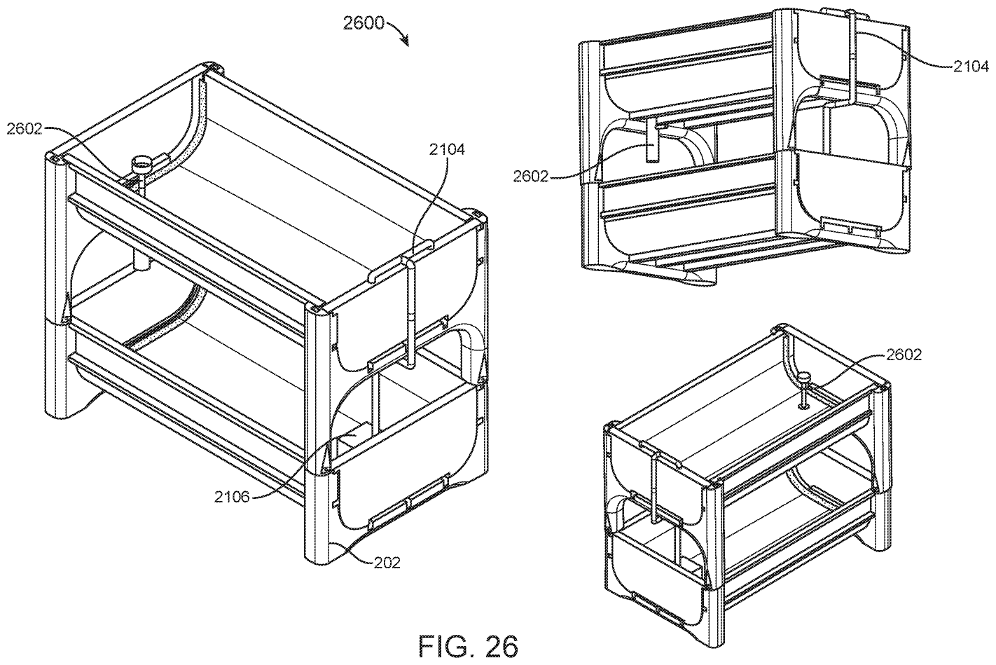

FIG. 26 illustrates a schematic representation 2600 of side elevation and bottom view of the modular tank system 100 utilized as the flood and drain (FD) aquaponics system comprising an automatic siphon 2602, a pump 2106 and the inlet pipe 2104 interconnecting the modular tank system of the FD aquaponics system and depicting details of the automatic siphon 2602 extending between the vertically stacked modular tank system 100 of the FD aquaponics system.

Embodiment in accordance with the present invention and referring to FIG. 26 in detail, the modular tank system 100 is utilized as the flood and drain (FD) aquaponics system for growing plants, flowers, or vegetables etc., is described herein. The modular tank system 100 used as an flood and drain aquaponics system comprising the first modular tank system 100 configured for holding the plants and containing support medium required for growing plants, the second modular tank system 100 configured for raising aquatic animals such as but limited to fish, snails, crayfish or prawns etc., the pump 2106 configured to pump water from the second modular tank system 100 to the first modular tank system, and the inlet pipe 2104 of the piping assembly configured for interconnecting and circulating water between the two modular tank system 100, automatic siphon 2602 configured for regulating the flow of water in the first modular tank system 100 configured for holding the plants. The first modular tank system 100 and second modular tank system 100 are vertically stacked.

Further, the first modular tank system 100 configured for holding the plants is modified for utilizing as the flood and drain aquaponics system. The liner 702 of the first modular tank system 100 must contain an opening for holding the automatic siphon 2602. The opening in the liner 702 may be a hole, circular opening and rounded opening for retaining the automatic siphon 2602.

Further, the inlet pipe 2104 of the piping assembly configured for interconnecting and circulating water between the two modular tank systems 100 is installed beneath the H-support 202 of the modular tank system 100 and clamped at respective H-support for securing and retaining the inlet pipe 2104 of the piping assembly in place.

In one exemplary embodiment of the present invention, the modular tank system 100 is utilized as the flood and drain (FD) aquaponics system is described herein in detail. The first and second modular tank systems 100 are vertically stacked. The first modular tank system 100 configured for holding plants is filled with supporting medium such as but not limited to hydroton, gravels, perlite, expanded clay pebbles, peat moss, pea gravel, coconut coir etc. and the automatic siphon 2602 is inserted in the liner 702 of the first modular tank system 100 in communication with the second modular tank system 100 configured for raising aquatic animals. The height of the automatic siphon 2602 can be adjusted according to the depth of the first modular tank system 100 configured for holding the plants and height of the support medium. Further, the pump 2106 installed in the second modular tank 100 configured for raising aquatic animals, pumps water continuously which is further transferred to the first modular tank system 100 configured for holding the plants. When the water level reaches to the pre-determined level in the first modular tank system 100 configured for holding plants, the water starts draining through the drain pipe of the automatic siphon 2602 in the second modular tank 100 configured for raising aquatic animals. The flood and drain cycle of water repeats itself depending upon the water required for the growing plants and the water level is maintained and regulated by the automatic siphon 2602.

The solid support medium serves the dual purposes of providing structure for plant roots to grow in and surface area allowing proliferation of aerobic nitrifying bacteria, which are essential for converting nitrogen in the effluent to forms suited to the plants' nutrient uptake. This alternation between flooding and draining process in the modular tank system ensures that the plants have both fresh nutrients and adequate airflow in the root zone. This replenishes the oxygen levels for plants and bacteria. It also ensures that enough moisture is in the support medium at all times so the bacteria can thrive in their optimum conditions.

The automatic siphon 2602 extends between the vertically stacked modular tank systems 100. It is also clear that the excess water from the first modular tank system 100 configured for holding plants is drained out through the drain pipe in the second modular tank system 100 for raising the aquatic animals.

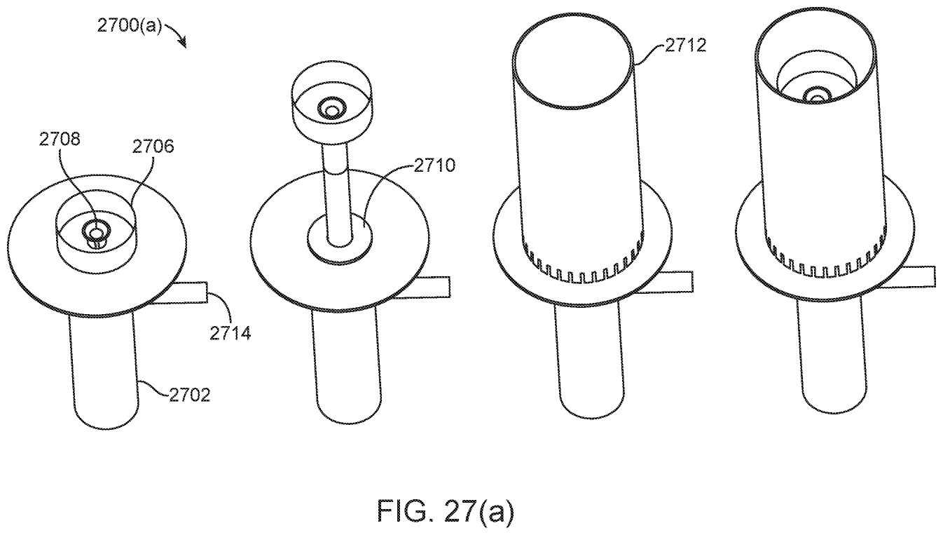

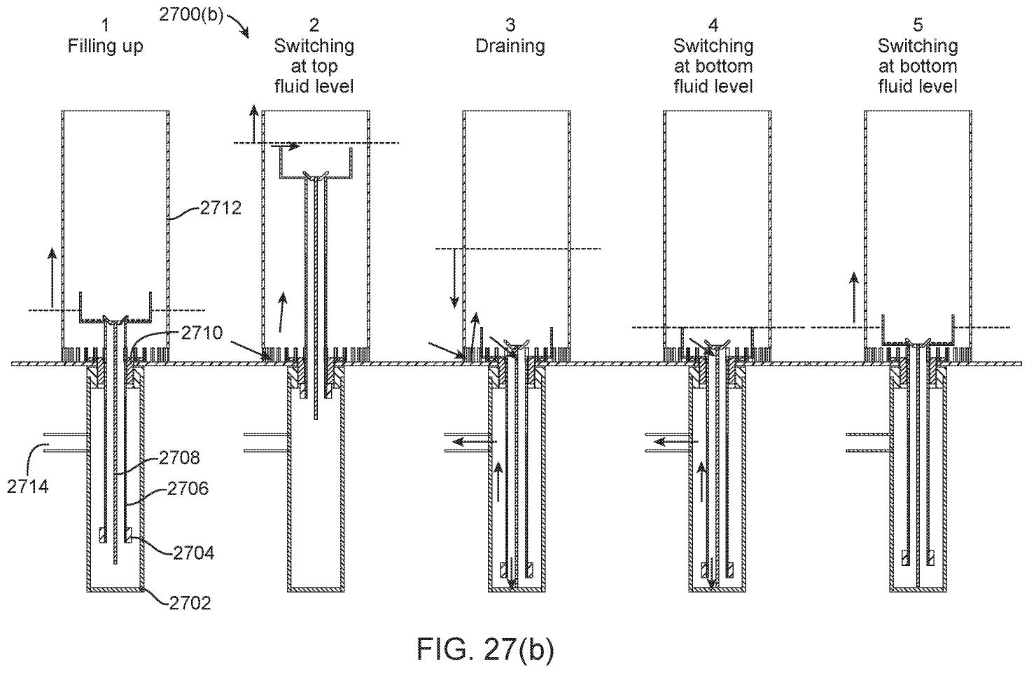

FIG. 27 (a) illustrates schematic representation 2700 (a) of 3-D view of the automatic siphon 2602 detailing different positions of the automatic siphon 2602 and its components.

The automatic siphon 2602 comprising collector 2702 configured to collect water flowing in the modular tank system 100; locking screw 2704 configured for retaining floater 2706 in place, during filling process of the modular tank system 100, the floater 2706 configured to move up as water filled up in the modular tank system 100, plunger 2708 configured for controlling the closing and opening of the floater 2706 during filling and draining processes, sealing mechanical assembly 2710 configured for retaining the floater in place, protecting sleeve 2712 configured for protecting the floater 2706 from the support medium such as but not limited to gravel, clay etc. and allowing free movement of the floater 2706 and the drain pipe 2714 configured for draining water from the collector 2702 when water level in the automatic siphon 2602 reaches to a predetermined level.

The automatic siphon 2602 can be utilized in any other applications requiring regulation of level of water or in place of traditionally used siphon for regulating the level of water.

FIG. 27 (b) illustrates a schematic representation of 2700 (b) sectional view of automatic siphon 2602 detailing the position of automatic siphon 2602 and its components and showing the functioning of the automatic siphon 2602 during filling and draining position of the first modular tank system 100 configured for holding plants in detail.

The functioning of the automatic siphon 2602 is sub-divided in four phases: 1) Filling Up; 2) Switching at top fluid level; 3) Draining; and 4) Switching at bottom fluid level.

During the filling phase of the first modular tank system 100 configured for holding plants, the floater 2706 is empty and floats in the collector 2702 of the automatic siphon 2602. The plunger 2708 closes the floater 2706 opening, as the bottom end of the floater 2706 is not touching the bottom end of the collector 2702. Further, as the fluid starts filling in the first modular tank system 100 configured for holding plants, the floater 2706 and plunger 2708 of the automatic siphon 2602 moves upwards slowly.

During the second phase of functioning of the automatic siphon 2602, when the level of the water reaches to the maximum pre-determined level it switches off at the top fluid level. When the first modular tank system 100 is entirely filled with water and reaches to the maximum pre-determined level, the floater 2706 reaches at the top position of the collector 2702 and the locking screw 2704 closes down the upward movement of the floater 2706 and the plunger 2708. The sealing mechanical assembly 2710 blocks upward movement of the floater 2706 by attaching with the locking screw 2704 of the automatic siphon 2602.

During the third phase of functioning of the automatic siphon 2602 when the excess water is to be drained is the draining position. The floater 2706 sinks and dropped to its lower position. The plunger 2708 opens up the opening of the floater 2706 and the water starts flowing down through the floater 2706 from the first modular tank system 100. The plunger 2708 touches the bottom end of the collector 2702 and the excess water drains outs through the drain pipe 2714 of the automatic siphon 2602. The protecting sleeve 2712 forces water to pass through bottom section of the modular tank system 100 allowing a proper cleaning of the modular tank system 100.

During the fourth phase of functioning of the automatic siphon 2602 that is when excess water is drained out and water level reaches to minimum pre-determined level. The water level in the first modular tank system 100 has dropped below the top part of the floater 2706; the plunger 2708 again closes down the opening of the floater 2706.

The foregoing discussion of the present invention has been presented for purposes of illustration and description. The foregoing is not intended to limit the present invention to the form or forms disclosed herein. In the foregoing Detailed Description for example, various features of the present invention are grouped together in one or more embodiments, configurations, or aspects, for the purpose of streamlining the disclosure. The features of the embodiments, configurations, or aspects of the present invention may be combined in alternate embodiments, configurations, or aspects other than those discussed above. This method of disclosure is not to be interpreted as reflecting an intention that the present invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the present invention.

Moreover, though the description of the present invention has included descriptions of one or more embodiments, configurations, or aspects, and certain variations and modifications, other variations, combinations, and modifications that are within the scope of the present invention, e.g., as may be within the skill and knowledge of those in the art, after understanding the present disclosure. It is intended to obtain rights which include alternative embodiments, configurations, or aspects, to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. An integrated and long continuous profile modular tank system, the modular tank system comprising:
a) at least two or more H-supports configured for connecting end-caps, lateral bars, liners and consecutive single modular tank, elevating the tank up to a healthy working height, transmitting the weight of the modular tank system to the ground, and maintaining the mechanical integrity of the tank system;
b) at least two or more end-caps configured to terminate the modular tank system at respective ends;
c) lateral bars configured to transmit horizontal mechanical force between the at least two end-caps via at least two H-supports;
d) one or more liners configured to hold the intended content of the modular tank system; and
e) two or more linear seals consist of outer seal and inner seal configured to provide a hydraulic seal for leak-proofing the modular tank system.

2. The modular tank system, as claimed in claim 1, wherein the H-support comprising pre-fabricated grooves and surface areas for holding the linear seal, the lateral bars, the locking bar, the end-caps and the liner.

3. The modular tank system, as claimed in claim 1, wherein the H-support comprising holes at bottom for fastening and tighten the H-support to the ground.

4. The modular tank system, as claimed in claim 1, wherein the H-support comprising holes at top end for holding the 3-part interlocking bar system and vertically stacked modular tank system.

5. The modular tank system, as claimed in claim 1, wherein the end-cap comprising pre-fabricated top-end clamping connectors which locked inside the H-Support fitted with a locking bar, for transmitting lateral mechanical force to the respective H-support.

6. The modular tank system, as claimed in claim 1, wherein the lateral bar comprising pre-fabricated interlocking apertures fitted inside the H-support for transmitting horizontal mechanical force between the H-supports.

7. The modular tank system, as claimed in claim 1, wherein the liner fitted inside the H-supports and multiple lateral bars for holding the intended content of the modular tank system.

8. The modular tank system, as claimed in claim 1, wherein the outer seal is featured on each side as a soft rectangular linear spacer designed to space the seal between the liners and end-caps and allow flexibility of the central seal locking mechanism with the inner seal, a series of half o-ring seal, and an edge lip seal configured to seal on the liners and end-caps outer surface.

9. The modular tank system, as claimed in claim 1, wherein the inner seal is featured on each side as a series of sealing fins and an edge lip seal to seal on the liners and end-caps inner surface.

10. The modular tank system, as claimed in claim 1, wherein the single modular tank comprising at least two H-supports which are inter-connected by using multiple lateral bars; at least two end-caps; at least two outer seals; at least one liner is configured to fitted inside the supporting structure formed by at least two H-supports and multiple lateral bars; and at least two inner seals is clipped over the end-cap and liner onto the outer seals to form a linear hydraulic seal.

11. The modular tank system, as claimed in claim 1, wherein further comprising multiple thermal insulation panels installed by squeezing in between the lateral bars for reducing thermal exchange between the content in the modular tank system and the external environment.

12. The modular tank system, as claimed in claim 1, wherein the modular tank system is assembled by:
a) putting the outer seal on the first H-support;
b) inserting the locking bar horizontally inside the horizontal rectangular groove of the H-support;
c) sliding the end-cap in the first H-support with the outer seal in place by interlocking pre-fabricated top-end clamping connectors inside the grooves of the H-Support fitted with a locking bar;
d) placing the second H-support, inserting multiple lateral bars between the at least two H-supports;
e) placing the outer seal, the locking bar, and the end-cap in respective position with respect to the second H-support and thus forming a supporting structure;
f) putting the liner in place in the supporting structure;
g) clipping the at least two inner seals inside the outer seals over the liner and end-caps by applying thumb pressure over and thus forming a single hydraulically sealed modular tank;
h) increasing the length of the modular tank system simply by adding one or more H-supports, the one or more outer seals, the one or more lateral bars and the one or more liner and the one or more inner seals as required between the at least two end-caps in respective positions;
i) fitting the last H-support with the locking bar and the outer seal in place and sliding the second end-cap in the last H-support with outer seal in place once the desired length is reached;
j) clipping at least two inner seals over the liner and end-caps inside the outer seals by applying thumb pressure over to form a hydraulically sealed modular tank system of required length and specifications.

13. The modular tank system, as claimed in claim 1, wherein the multiple lateral bars gets engaged in the interlocking grooves of the H-support forming a U like interlocked structure for transmitting horizontal mechanical force to the H-support.

14.-20. (canceled)

21. The modular tank system, as claimed in claim 12, wherein the multiple lateral bars gets engaged in the interlocking grooves of the H-support forming a U like interlocked structure for transmitting horizontal mechanical force to the H-support.
